(19) United States
(12) Patent Application Publication
(10) Pub. No.: US 2006/0033916 A1
(43) Pub. Date: Feb. 16, 2006

(54) Selection method, exposure method, selection unit, exposure apparatus, and device manufacturing method

(75) Inventors: Taro Sugihara, Shinagawa-ku (JP); Ayako Sukegawa, Fukaya-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 11/250,435

(22) Filed: Oct. 17, 2005

Related U.S. Application Data
(63) Continuation of application No. PCT/JP04/05474, filed on Apr. 6, 2004.

(30) Foreign Application Priority Data
Apr. 17, 2003 (JP) 2003-112933

(51) Int. Cl. G01B 11/00

(52) U.S. Cl. 356/401

(57) ABSTRACT

In step 401, a subset of an arbitrary plurality of numbers of shot areas is selected from a plurality of shot areas. Then, in step 403, based on the design value of position information related to shot areas included in the subset information on a predetermined accuracy index relative to the position information, the maximum likelihood estimates of the error parameter information for the arrangement on a wafer is calculated in the case where the shot areas are used as measurement shot areas. Then, in step 405, based on the estimated error parameters, overlay error is calculated, and in step 407, subsets whose overlay error satisfies a predetermined condition are selected in step 407. And from the subsets that have been selected, a subset having the most preferable moving sequence related to the total movement time between shot areas is selected.

### CROSS-REFERENCE RELATED APPLICATIONS

This is a continuation of International Application PCT/JP2004/005474, with an international filing date of Apr. 16, 2004, the entire content of which being hereby incorporated herein by reference, which was not published in English.

### BACKGOUND OF THE INVENTION

1. Field of the Invention

The present invention relates to a selection method, an exposure method, a selection unit, an exposure apparatus, and a device manufacturing method, and more particularly to a selection method of selecting a desired area subject to measurement from a plurality of areas subject to measurement formed on an object, an exposure method using the selection method, a selection unit that selects a desired area subject to measurement from a plurality of areas subject to measurement formed on an object, an exposure apparatus equipped with the selection unit, and a device manufacturing method using the exposure method or the exposure apparatus.

2. Description of the Related Art

In a lithography process for manufacturing semiconductor devices, liquid crystal display devices, or the like, an exposure apparatus that transfers a pattern formed on a mask or a reticle (hereinafter, generally referred to “reticle”) onto a substrate (hereinafter, generally referred to “wafer”) such as a wafer or a glass plate, on which resist or the like is coated, via a projection optical system, is mainly used, such as, for example, a reduction projection exposure apparatus by a step-and-repeat method (a so-called stepper) or a projection exposure apparatus of a sequentially moving type (hereinafter, referred to together as “exposure apparatus”) such as a scanning type projection exposure apparatus by a step-and-scan method (a so-called scanning stepper), which is an improvement of the stepper.

In the case of manufacturing semiconductor devices or the like, different circuit patterns are formed in many layers on a wafer. However, an inconvenience may occur in the characteristics of the circuit if the overlay accuracy between the layers is poor. In such a case, the chip does not satisfy desired characteristics, and in the worst case, the chip become defective and reduces the yield. Accordingly, in the exposure process, it becomes important to accurately overlay a reticle on which a circuit pattern is formed on a pattern that is already formed in each shot area of a wafer when transfer is performed.

Therefore, in the exposure process, alignment marks are arranged in each of a plurality of shot areas on the wafer in advance, and the position (coordinate value) of the alignment marks on a stage coordinate system of a wafer stage on which the wafer is mounted, (a coordinate system that sets the movement of the wafer stage, which is usually set by the measurement axes of a laser interferometer) is detected. After the detection, based on the mark position information and positional information (measured in advance) on the projection position of a known reticle pattern, the so-called wafer alignment (wafer alignment measurement) where a positional relationship between each shot area and the projection position of the reticle pattern is obtained is performed.

One of the wafer alignment methods is the Enhanced Global Alignment, or the so-called EGA method. In the EGA method, in prior to the exposure of the second layer and the subsequent layers, first of all, from a plurality of shot areas formed on the wafer, such as for example, at least 3 (usually 8 to 15) shot areas that are located at the center and near the periphery of the wafer are specified, and the position of the alignment marks arranged in each shot area is measured (sample alignment), using an alignment sensor.

Then, based on the position of the alignment marks (sample marks) that are measured and the design values of each sample mark, error parameters related to a position deviation between an arrangement coordinate system set by the arrangement of the shot areas on the wafer and the stage coordinate system described above, that is, a total of six error parameters showing an offset of the center position of the wafer, expansion/contraction degree of the wafer, residual rotation amount of the wafer, and the orthogonal degree of the wafer stage (or the orthogonal degree of the shot columns) are decided, using some sort of a statistical method (e.g., the least-squares method) (for offset and expansion/contraction degree, because error parameters exist for each coordinate axis in the two-dimensional stage coordinate system, the number of error parameters is 6).

Further, based on the values of the error parameters that have been decided and design arrangement coordinates of all the shot areas on the wafer, position information for aligning all the shot areas on the wafer to predetermined points (projection positions of the reticle pattern) is calculated, and when exposure is performed, the wafer stage is moved based on the position information of each shot area that has been calculated.

When the EGA method is used, because position measurement of the marks is not necessary after the position of a small number (about 3 to 15, as is described above) of the marks is measured when compared to the total number of shots (e.g., 51 shots or 60 shots) on the wafer, an improvement in throughput can be expected. Further, since in the EGA method, the arrangement characteristics of the shot areas can be recognized with high precision unlike a conventional global alignment method, the alignment accuracy of EGA method is also extremely good to other shot areas to which sample alignment was not performed, and when sample alignment is performed on a sufficient number of shot areas, individual mark detection errors are averaged by statistical calculation and the alignment accuracy equivalent to, or even better than the alignment per shot (die-by-die method or site-by-site method) can be expected for all shot areas on the entire surface of wafer (for example, refer to Kokai (Japanese Unexamined Patent Application Publication) No. 61-44429, and the corresponding U.S. Pat. No. 4,780,617 (referred to as “Document 1”)).

However, in the EGA method, although the reliability of the alignment accuracy improves when the number of marks to be measured increases, from the viewpoint of throughput, increasing the number of marks to be measured is not desirable. Further, in the EGA method, in order to improve the alignment accuracy, marks are experientially selected so that the position of the marks to be measured are dispersed as much as possible, as in for example, selecting a plurality of marks that are located inside the outline of the wafer and form vertex angles of a polygon as the marks to be measured. However, in the EGA method, because the marks to be measured are sequentially detected by an alignment sensor, when the position of the marks to be measured are too far apart, the moving distance of the wafer stage in order to position a mark to be measured within the detection field of the alignment sensor becomes long, which is also not desirable from the viewpoint of throughput.

Consequently, methods of optimizing the number or the arrangement of the measurement marks in the EGA method by using the overlay accuracy (error) of the shot areas as an index have conventionally been suggested (for example, refer to Kokai (Japanese Unexamined Patent Application Publication) No. 4-324615 (hereinafter referred to as “Document 2”), Kokai (Japanese Unexamined Patent Application Publication) No. 5-217848 (hereinafter referred to as “Document 3”), Kokai (Japanese Unexamined Patent Application Publication) No. 6-232028 (hereinafter referred to as “Document 4”), Kokai (Japanese Unexamined Patent Application Publication) No. 6-302490 (hereinafter referred to as “Document 5”), and International Publication No. WO02/061505 pamphlet (hereinafter referred to as “Document 6), or the like), and methods for optimizing a movement path (movement sequence) of the wafer stage in favor of throughput when measuring the marks have been suggested (for example, refer to Kokai (Japanese Unexamined Patent Application Publication) No. 10-312961 (hereinafter referred to as “Document 7), or the like).

Recently, due to finer device patterns, higher precision is required in the alignment accuracy of the exposure apparatus. In addition, requirements to throughput in the exposure process are becoming tighter. Accordingly, optimization of the number, the arrangement, and the movement sequence (selection of the optimum measurement marks) of the measurement marks that affect the alignment accuracy and the throughput have become more and more important.

However, for example, the optimizing methods disclosed in the above Documents 2 to 6 are methods where alignment marks are actually measured, and the number and the arrangement of the measurement marks in the EGA method are optimized based on the index according to the measurement values, which means that when optimization is performed the position of the marks are supposed to be actually measured, which in turn took some time.

Furthermore, in the method disclosed in the above Document 7, the subject to optimization is only the movement sequence, and the number and the arrangement of measurement marks in the EGA method are not subject to optimization, accordingly, the method could not optimize all of the number, the arrangement, and the movement sequence of the measurement marks.

### SUMMARY OF THE INVENTION

The present invention was made under such circumstances, and has as its first object to provide a selection method in which the number, the arrangement, and the movement sequence on measurement of the measurement marks can be selected so as to satisfy the requirements with respect to alignment accuracy and throughput, or to shorten the required time.

Further, the second object of the present invention is to provide an exposure method in which high exposure accuracy and high throughput can be achieved at the same time.

Further, the third object of the present invention is to provide a selection unit that can select the number, the arrangement, and the movement sequence on measurement of the measurement marks so as to satisfy the requirements with respect to alignment accuracy and throughput, or to shorten the required time.

Furthermore, the fourth object of the present invention is to provide an exposure apparatus that can achieve high exposure accuracy and high throughput at the same time.

Still further, the fifth object of the present invention is to provide a device manufacturing method in which the productivity of microdevices can be increased.

According to a first aspect of the present invention, there is provided a first selection method in which a desired area subject to measurement is selected from a plurality of areas subject to measurement formed on an object, the method comprising: a first step in which an arbitrary plurality of numbers of areas subject to measurement are selected from the plurality of areas subject to measurement; and a second step in which error parameter information on the arrangement of the areas subject to measurement on the object is estimated, based on a design value of the position information of each of the plurality of areas subject to measurement selected in the first step and information on a predetermined accuracy index related to the position information of the areas subject to measurement.

According to this method, in the first step, an arbitrary plurality of areas subject to measurement is selected from a plurality of areas subject to measurement in the first step. Then, in the second step, the error parameter information on the arrangement of the areas subject to measurement on the object that has been selected is estimated, based on the design value of the position information of each of the plurality of areas subject to measurement selected and information on the predetermined accuracy index related to the position information of the areas subject to measurement. That is, according to the present invention, the error parameter information on the arrangement of the selected areas subject to measurement on the object can be obtained within a short time, without actually measuring the areas subject to exposure.

In this case, the method can further comprise: a third step in which error information between the design value of the position information of all areas subject to measurement formed on the object and a calculated value of the position information of the areas subject to measurement based on the error parameter information is estimated, based on the error parameter information estimated in the second step.

According to this method, in the third step, the error information between the design value and the calculated value of the position information of all the measurement areas can be estimated, based on the estimated error parameter information.

Further, in the first selection method of the present invention, in the first step, a plurality of subsets of areas subject to measurement can be selected, the subsets each including an arbitrary plurality of numbers of areas subject to measurement, and in the second step, the error parameter information can be estimated for each of the subsets, and the method can further comprise: a third step in which a subset satisfying a first predetermined condition is selected from the plurality of subsets that have been selected, based on the error parameter information estimated in the second step.

According to this method, because a subset of areas subject to measurement satisfying the first predetermined condition (for example, satisfies a requirement for alignment accuracy serving as accuracy index) can be selected based on the estimated error parameter in the third step, the optimization of the number or the arrangement of the measurement marks can be performed in a short time.

In this case, the first predetermined condition can include a condition where one of information on error of the error parameter information and information on overlay error of all areas subject to measurement calculated based on the error parameter information is better than a predetermined accuracy threshold value.

In this case, when a plurality of subsets selected in the third step exists, the method can further comprise: a fourth step in which an optimal subset is selected, using a condition different from the first predetermined condition.

In this case, in the third step, when a plurality of subsets are selected that reciprocally have a different numbers of areas subject to measurement, in the fourth step, a subset that has a smaller number of the areas subject to measurement can be selected as the optimal subset.

In this case, in the fourth step, a subset that has the most preferable movement sequence related to the total movement time between the plurality of areas subject to measurement included in each of the subsets can be selected as the optimal subset.

In this case, in the fourth step, the movement sequence can be obtained for each of the subsets using at least one search method of an operations research like method, an evolutionary computation method, and a combination of the two methods, and the optimal subset can be selected by comparing the movement sequences that have been obtained.

In this case, the method can further comprise: a measurement step in which a plurality of areas subject to measurement included in the optimal subset selected in the fourth step are sequentially measured, using a movement sequence obtained for the optimal subset.

In this case, the method can further comprise: a fifth step in which a plurality of areas subject to measurement that is formed on the object and also satisfies a second predetermined condition are selected as an area subject to measurement for measuring a deviation of a coordinate system on the object with respect to a coordinate system that sets a movement position of a moving body where the object is mounted, wherein in the fifth step, at least one of the plurality of areas subject to measurement that satisfies the second predetermined condition can be selected from an area subject to measurement areas included in a subset selected in the third step.

In this case, the second predetermined condition can include a condition where a reciprocal distance is equal to or longer than a predetermined distance.

In this case, the second predetermined condition can include a condition of having the most preferable movement sequence related to a total movement time, the total movement time being a total of a reciprocal movement time and movement time among a plurality of areas subject to measurement included in a subset selected in the third step.

In this case, the method can further comprise: a measurement step in which a plurality of areas subject to measurement selected in the fifth step and a plurality of areas subject to measurement included in the subset selected in the third step are sequentially measured, using the movement sequence.

Further, in the first selection method of the present invention, the predetermined accuracy index can include an index related to measurement reproducibility of the position information of areas subject to measurement.

Furthermore, according to a second aspect of the present invention, there is provided a second selection method in which a desired area subject to measurement is selected from a plurality of areas subject to measurement formed on an object, the method comprising: a selecting step in which an arbitrary plurality of areas subject to measurement having the most preferable movement sequence related to the total movement time between the areas subject to measurement are selected from the plurality of areas subject to measurement.

According to this method, in the selecting step, since areas subject to measurement having the most preferable movement sequence related to the total movement time between the areas subject to measurement are selected from the areas subject to measurement on the object, the time required for the measurement can be shortened when the selected areas subject to measurement are used as the actual areas subject to measurement.

In this case, the selecting step can comprise: a first step in which a plurality of subsets of areas subject to measurement are selected, the subsets each including an arbitrary number of areas subject to measurement; a second step in which the most preferable movement sequence related to the total movement time between a plurality of areas subject to measurement included in each of the subsets selected in the first step is obtained for each of the subsets; and a third step in which solutions of the movement sequence obtained for each of the subsets in the second step are compared, and a subset whose the total movement time is the shortest is decided.

Further, in this case, the area subject to measurement included in the subsets selected in the first step each can have information on overlay error, which is better than a predetermined accuracy threshold value.

In this case, the information on the overlay error can be obtained via statistical processing calculation, the calculation performed on information related to a predetermined accuracy index on the position information of the measurement area and the design value of the position information of each of the arbitrary number of areas subject to measurement.

Further, in the second selection method of the present invention, in the selecting step, as the arbitrary plurality of areas subject to measurement, at least one of an area subject to measurement for measuring a deviation of a coordinate system on the object with respect to a coordinate system on a moving body where the object is mounted and an area subject to measurement for obtaining error information on the arrangement of the plurality of areas subject to measurement on the object can be selected.

In this case, in the selecting step, the arbitrary plurality of areas subject to measurement can be selected, using a search method in any one of an operations research like method, an evolutionary computation method, and a combination of the two methods.

In this case, the method can further comprise: a measurement step in which the arbitrary plurality of areas subject to measurement decided in the selecting step are sequentially measured, using the movement sequence that has been obtained using the search method.

According to a third aspect of the present invention, there is provided a third selecting method in which a desired area subject to measurement is selected from a plurality of areas subject to measurement formed on an object, the method comprising: a first step in which a plurality of areas subject to measurement are selected that are areas subject to measurement so as to obtain error parameter information on the arrangement of the plurality of areas subject to measurement on the object, and also satisfies a predetermined accuracy criterion; and the second step in which of the plurality of areas subject to measurement selected in the first step, an arbitrary plurality of areas subject to measurement are selected that have the most preferable movement sequence related to the total movement time between the areas subject to measurement.

According to this method, in the first step, a plurality of areas subject to measurement that satisfies a predetermined accuracy criterion is selected in the first step. Then, in the second step, an arbitrary plurality of numbers of areas subject to measurement having the most preferable movement sequence related to the total movement time between the areas subject to measurement are further selected from a plurality of areas subject to measurement that have been selected. By such an operation, optimization on the number and the arrangement of measurement marks and the movement sequence during measurement that can satisfy both the requirement for alignment accuracy and the requirement for throughput can be performed.

In this case, the error parameter information can be obtained by processing the design value of the position information of each of the plurality of areas subject to measurement selected in the first step and information on a predetermined accuracy index related to the position information of the areas subject to measurement by statistical calculation.

Further, in the third selection method of the present invention, the predetermined accuracy criterion can include a predetermined threshold value for one of information on the error of the error parameter information and information on overlay error of all the areas subject to measurement that are calculated based on the error parameter.

Furthermore, according to a fourth aspect of the present invention, there is provided an exposure method, comprising: a step in which position information of marks serving as areas subject to measurement formed on a substrate is detected, using the first, second, and third selection method of the present invention; and a step in which a predetermined pattern is transferred onto the substrate while position control of the substrate is performed based on the detection result.

According to this method, the position information of marks serving as the areas subject to measurement formed on the substrate is detected with high accuracy within a short time using the first, second, and third selection methods of the present invention, and transfer is performed in a state where position control of the substrate is being performed, based on the detection results of the detection, therefore, both high exposure accuracy and high throughput can be achieved.

According to a fifth aspect of the present invention, there is provided a device manufacturing method including a lithography step, wherein in the lithography step, exposure is performed using the exposure method according to the present invention. In such a case, since exposure is performed using the exposure method of the present invention, both high exposure accuracy and high throughput can be realized, which makes it possible to improve the productivity of high integration devices.

According to a sixth aspect of the present invention, there is provided a first selection unit that selects a desired area subject to measurement from a plurality of areas subject to measurement formed on an object, the unit comprising: a first area selecting unit that selects an arbitrary plurality of numbers of areas subject to measurement from the plurality of areas subject to measurement; and an estimation unit that estimates error parameter information on the arrangement of the areas subject to measurement on the object, based on a design value of the position information of each of the plurality of areas subject to measurement selected by the first area selecting unit and information on a predetermined accuracy index related to the position information of the areas subject to measurement.

According to the unit, the first area-selecting unit selects an arbitrary plurality of numbers of areas subject to measurement from the plurality of areas subject to measurement. Then, the estimation device estimates the error parameter information on the arrangement of the selected measurement areas on the object, based on the design value of the position information related to the plurality of areas subject to measurement that have been selected and information for a predetermined accuracy index related to the position information. Accordingly, it becomes possible to calculate the error parameter information for the arrangement of the areas subject to measurement on the object within a short time without actually measuring the position information on the areas subject to measurement.

In this case, the first area selecting unit can select a plurality of subsets of areas subject to measurement, the subsets each including an arbitrary plurality of numbers of areas subject to measurement, and the estimation unit can estimate the error parameter information for each of the subsets, and the selection unit can further comprise: a set selecting unit that selects a subset satisfying a first predetermined condition from the plurality of subsets that have been selected, based on the error parameter information estimated by the estimation unit.

In this case, the first predetermined condition can include a condition where one of information on error of the error parameter information and information on overlay error of all areas subject to measurement calculated based on the error parameter information is better than a predetermined accuracy threshold value.

Further, in the first selection unit of the present invention, the set selecting unit can select an optimal subset using a condition different from the first predetermined condition when a plurality of selected subsets exists.

In this case, the set selecting unit can select a subset that has the most preferable movement sequence related to the total movement time between the plurality of areas subject to measurement included in each of the subsets as the optimal subset.

In this case, the unit can further comprise: a measurement unit that sequentially measures a plurality of areas subject to measurement included in the optimal subset selected by the set selecting unit are sequentially measured, using a movement sequence obtained for the optimal subset.

Further, the first selection unit of the present invention can further comprise: a second area selecting unit that selects a plurality of areas subject to measurement that is formed on the object and also satisfies a second predetermined condition are selected as an area subject to measurement for measuring a deviation of a coordinate system on the object with respect to a coordinate system that sets a movement position of a moving body where the object is mounted, wherein the second area selecting unit selects at least one of the plurality of areas subject to measurement that satisfies the second predetermined condition from an area subject to measurement areas included in a subset selected by the set selecting unit.

In this case, the second predetermined condition can include a condition where a reciprocal distance is equal to or longer than a predetermined distance.

In this case, the second predetermined condition can include a condition of having the most preferable movement sequence related to a total movement time, the total movement time being a total of a reciprocal movement time and movement time among a plurality of areas subject to measurement included in a subset selected by the set selecting unit

Further, in the first selection unit of the present invention, the predetermined accuracy index can include an index related to measurement reproducibility of the position information of areas subject to measurement.

According to a seventh aspect of the present invention, there is provided a second selection unit that selects a desired area subject to measurement from a plurality of areas subject to measurement formed on an object, the unit comprising; a selecting unit that selects an arbitrary plurality of areas subject to measurement having the most preferable movement sequence related to the total movement time between the areas subject to measurement from the plurality of areas subject to measurement; and a measurement instrument that measures the selected plurality of areas subject to measurement.

According to the unit, the selecting unit selects areas subject to measurement having the most preferable movement sequence related to the total movement time between the areas subject to measurement from the areas subject to measurement on the object, therefore, when the areas subject to measurement that have been selected are used as the actual measurement areas, time required for their measurement can be shortened.

In this case, the selecting unit can comprise: a set selecting unit that selects a plurality of subsets of areas subject to measurement, the subsets each including an arbitrary number of areas subject to measurement; a calculation unit that obtains the most preferable movement sequence related to the total movement time between a plurality of areas subject to measurement included in each of the subsets selected by the set selecting unit is obtained for each of the subsets; and a decision making unit that compares solutions of the movement sequence obtained for each of the subsets by the calculation unit, and decides a subset whose the total movement time is the shortest.

Further, in the second selection unit of the present invention, the area subject to measurement included in the subsets selected by set selecting unit each can have information on overlay error, which is better than a predetermined accuracy threshold value.

Furthermore, in the second selection unit of the present invention, the selecting unit can select at least one of an area subject to measurement for measuring a deviation of a coordinate system on the object with respect to a coordinate system on a moving body where the object is mounted and an area subject to measurement for obtaining error information on the arrangement of the plurality of areas subject to measurement on the object as the arbitrary plurality of areas subject to measurement.

In this case, the selecting unit can select the arbitrary plurality of areas subject to measurement, using a search method in any one of an operations research like method, an evolutionary computation method, and a combination of the two methods.

In this case, the exposure apparatus can further comprise the measurement instrument, which sequentially measures the arbitrary plurality of areas subject to measurement decided by the selecting unit, using the movement sequence that has been obtained using the search method.

According to an eighth aspect of the present invention, there is provided a third selection unit that selects a desired measurement area from a plurality of measurement areas formed on an object, the unit comprising: a first selecting device that selects a plurality of areas subject to measurement that are areas subject to measurement so as to obtain error parameter information on the arrangement of the plurality of areas subject to measurement on the object, and also satisfies a predetermined accuracy criterion; and a second selecting device that selects an arbitrary plurality of areas subject to measurement that have the most preferable movement sequence related to the total movement time between the areas subject to measurement from the plurality of areas subject to measurement selected by the first selecting device.

According to this unit, in the first selecting device, a plurality of areas subject to measurement that satisfies a predetermined accuracy criterion is selected. Then, in the second selecting device, an arbitrary plurality of numbers of areas subject to measurement having the most preferable movement sequence related to the total movement time between the areas subject to measurement are further selected from a plurality of areas subject to measurement that have been selected. Accordingly, optimization of the number and the arrangement of measurement marks and the moving sequence during measurement, which can satisfy both the requirement for alignment accuracy and the requirement for throughput can be performed.

According to a ninth aspect of the present invention, there is provided an exposure apparatus, comprising a selection unit according to the first, second and third selection unit in the present invention; a detection unit that detects the position information of marks serving as areas subject to measurement formed on a substrate based on measurement results of said selection unit; and a transfer unit that transfers a predetermined pattern onto said substrate while positional control of said substrate is performed based on detection results of said detection unit.

According to this apparatus, the position information of marks as the measurement areas formed on the substrate is detected with good accuracy by using the first, second and third selection units, and transfer is performed in the state where positional controls of the substrate is performed based on the detection result, so that both high exposure accuracy and high throughput can be realized

According to a tenth aspect of the present invention, there is provided a device manufacturing method including a lithography step, wherein in the lithography step, exposure is performed using the exposure apparatus of the present invention in the lithography step. In such a case, because exposure is performed using the exposure apparatus of the present invention, high exposure accuracy and high throughput can both be realized, and thus productivity of highly integrated devices can be improved.

### BRIEF DESCRIPTION OF THE DRAWINGS

In the accompanying drawings;

FIG. 1 is a view showing the schematic constitution of an exposure device according to an embodiment of the present invention;

FIG. 2A is a view showing the arrangement of shot areas on a wafer, and FIG. 2B is a view showing the arrangement of alignment marks on the wafer;

FIG. 3 is a flowchart showing a processing algorithm of a CPU in a main controller during exposure process in the exposure apparatus according to the embodiment of the present invention;

FIG. 4 is a flowchart (1) showing an optimization processing;

FIG. 5 is a flowchart (2) showing the optimization processing;

FIG. 6 is a flowchart (3) showing the optimization processing.

FIG. 7A is a view showing the arrangement of EGA measurement shot areas experientially selected, and FIG. 7B is a view showing the arrangement of EGA shot areas selected by optimization;

FIG. 8 is a flowchart for explaining an embodiment of the device manufacturing method according to the present invention; and

FIG. 9 is a flowchart showing the details of step 804 in FIG. 8.

### DESCRIPTION OF THE EMBODIMENTS

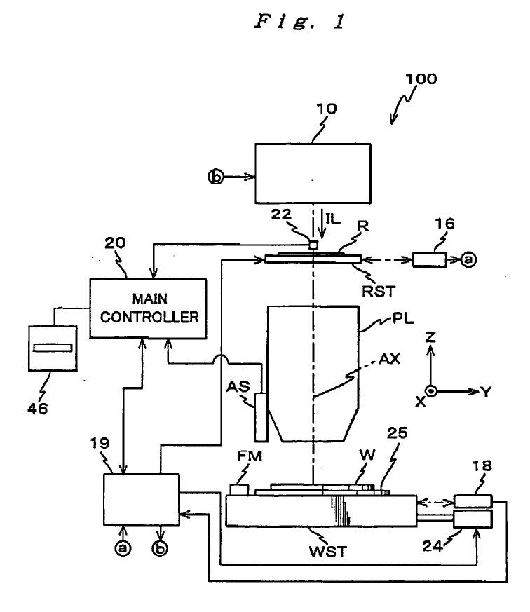

An embodiment of the present invention will be described below, referring to FIGS. 1 to 7B.

FIG. 1 shows the schematic constitution of an exposure apparatus 100 related to the embodiment to which the selection method and exposure method of the present invention are applied. Exposure apparatus 100 is a projection exposure apparatus by the step-and-scan method. Exposure apparatus 100 is equipped with an illumination system 10, a reticle stage RST that mounts a reticle R serving as a mask, a projection optical system PL, a wafer stage WST serving as a moving body on which a wafer W (substrate) serving as an object is mounted, an alignment detection system AS serving as a measuring instrument, and a main controller 20 that has overall control over the entire apparatus, and the like.

Illumination system 10, as is disclosed in Kokai (Japanese Unexamined Patent Application Publication) No. 6-349701 and its corresponding U.S. Pat. No. 5,534,970 or the like, is constituted including a light source, an illuminance uniformity optical system including an optical integrator, a relay lens, a variable ND filter, a variable field stop (also called a reticle blind or a masking blade), a dichroic mirror, and the like (all are not shown). As the optical integrator, a fly-eye lens, a rod integrator (internal reflection type integrator) or a diffractive optical element is used. As long as the national laws in designated states or elected states, to which this international application is applied, permit, the above disclosures of the publication and the U.S. patent are incorporated herein by reference.

In illumination system 10, on reticle R where a circuit pattern or the like is drawn, illumination light IL illuminates a slit-shaped illumination area (a rectangular illumination area extending narrowly in an X-axis direction) set by the reticle blind with a substantially uniform illuminance. As illumination light IL, deep ultraviolet light such as the KrF excimer laser beam (wavelength: 248 nm) or the ArF excimer laser beam (wavelength: 193 nm), vacuum ultraviolet light such as F₂ laser beam (wavelength: 157 nm), or the like is used. It is also possible to use an emission line (such as a g-line or an i-line) in an ultraviolet region emitted from an ultra high-pressure mercury lamp, as illumination light IL.

Reticle R is fixed on reticle stage RST, for example, by vacuum chucking. Reticle stage RST can be finely driven within an XY plane perpendicular to the optical axis (coincides with an optical axis AX of projection optical system PL (to be described later)) of illumination system 10, while being driven in a predetermined scanning direction (which is a Y-axis direction being the lateral direction within the page surface of FIG. 1) at a specified scanning speed, by a reticle stage drive section (not shown), which has a linear motor, a voice coil motor or the like as its drive source.

The position of the reticle stage RST within a stage movement plane is constantly detected by a reticle laser interferometer (hereinafter, referred to as a “reticle interferometer”) 16 with a resolution of about 0.5 to 1 nm. Although a reticle X interferometer and a reticle Y interferometer are actually arranged, FIG. 1 representatively shows them as reticle interferometer 16. At least one of the reticle X interferometer or the reticle Y interferometer is a dual-axis interferometer that has two measurement axes, such as the reticle Y interferometer, and based on the measurement values of the reticle Y interferometer, the rotation amount (yawing amount) in a θz direction (rotation direction around a Z-axis) can be also measured, in addition to the Y position of the reticle stage RST. The position information (including rotation information such as the yawing amount) of reticle stage RST sent from reticle interferometer 16 is supplied to a stage controller 19 and to main controller 20 via the unit. In response to a command from main controller 20, stage controller 19 drives and controls reticle stage RST via a reticle stage drive section (not shown) based on the position information of reticle stage RST.

Above reticle R, a pair of reticle alignment detection systems 22 (reticle alignment detection system 22 in depth of the page surface is not shown in FIG. 1) is arranged at a predetermined distance in the X-axis direction. Although it is omitted in the drawings, each reticle alignment detection system 22 is constituted including an episcopic illumination system for illuminating a mark subject to detection by an illumination light that has the same wavelength as exposure light IL and a detection system to pick up the image of the mark subject to detection. The detection system includes an image-forming optical system and an imaging device, and the imaging results (that is, the detection results of the mark by reticle alignment detection systems 22) are supplied to main controller 20. In this case, deflection mirrors (not shown) for guiding detection beams from reticle R to reticle alignment detection systems 22 are arranged freely movable, and when the exposure sequence begins, the deflection mirrors are severally withdrawn outside the optical path of exposure light IL, integrally with reticle alignment detection systems 22 by a drive unit (not shown) according to instructions from main controller 20.

Projection optical system PL is arranged below reticle stage RST in FIG. 1, and the direction of its optical axis AX is in the Z-axis direction. As projection optical system PL, a both-side telecentric dioptric system that has a predetermined reduction magnification (such as ¼ or ⅕ times) is used. Therefore, when the illumination area of reticle R is illuminated by illumination light IL from illumination system 10, a reduced image (partially inverted image) of the illumination area section of the circuit pattern of reticle R is projected on a projection area within a field of the projection optical system, which is conjugate with the illumination area on wafer W, via projection optical system PL, and is transferred onto the resist layer on the surface of wafer W.

Wafer stage WST is arranged on a base (not shown) below projection optical system PL in FIG. 1. On wafer stage WST, a wafer holder 25 is mounted, and on wafer holder 25, wafer W is fixed, for example, by vacuum chucking or the like.

Wafer stage WST is a single stage that can be driven in directions of five degrees of freedom, that is, in the X, Y, Z, θx (rotation direction around X-axis), and θy (rotation direction around Y-axis) directions, by a wafer stage drive section 24. As for the remaining θz direction, wafer stage WST (more specifically, wafer holder 25) may have a rotatable configuration, or the yawing error of wafer stage WST may be corrected by rotating the reticle stage RST side.

The position of wafer stage WST is constantly detected by a wafer laser interferometer (hereinafter, referred to as a “wafer interferometer”) 18, which is externally arranged, with a resolution of about 0.5 to 1 nm. Although an interferometer that has a measurement axis in the X-axis direction and an interferometer that has a measurement axis in the Y-axis direction are actually arranged, FIG. 1 representatively shows them as wafer interferometer 18. The interferometers are constituted by multi-axis interferometers that have a plurality of measurement axes, and with these interferometers, rotation (yawing (θz rotation, which is rotation around the Z-axis), pitching (θx rotation, which is rotation around the X-axis), rolling (θy rotation, which is rotation around the Y-axis)) of wafer stage WST can be measured, in addition to the X and Y positions.

In addition, in the vicinity of wafer W on wafer stage WST, a fiducial mark plate FM is fixed. The surface of fiducial mark plate FM is set to substantially the same height as the surface of wafer W, and on the surface, at least a pair of fiducial marks for reticle alignment, fiducial marks for baseline measurement of alignment detection system AS, and the like are formed.

Alignment detection system AS is an off-axis type alignment sensor arranged on a side surface of projection optical system PL. As alignment detection system AS, a sensor of an FIA (Field Image Alignment) system based on an image processing method is used. This sensor irradiates a broadband detection beam that does not expose the resist on the wafer on a target mark, picks up an image of the target mark formed on the photodetection surface by the reflection light from the target mark and an index image with a pick-up device (such as a CCD), and outputs the imaging signals. The sensor, however, is not limited to the FIA system sensor, and it is a matter of course that an alignment sensor that irradiates a coherent detection light on a target mark and detects the scattered light or diffracted light generated from the target mark, or a sensor that detects two diffracted lights (for example, the same order) generated from a target mark that are made to interfere can be used independently, or appropriately combined. The imaging results of alignment detection system AS are output to main controller 20.

The control system in FIG. 1 is mainly composed of main controller 20, stage controller 19, which operates under the control of the main controller, and the like. Main controller 20 is constituted including a so-called microcomputer (or workstation) made up of a CPU (Central Processing Unit), a main memory, and the like, and has overall control over the entire apparatus.

In addition, main controller 20 is externally connected to, for example, a storage unit made up of hard disks, an input unit configured including a pointing-device such as a key board and a mouse, a display unit such as a CRT display (or a liquid-crystal display) (none of which are shown), and a drive unit 46 which is an information recording medium such as CD (compact disc), DVD (digital versatile disc), MO (magneto-optical disc), or FD (flexible disc). In the information recording medium (hereinafter referred to as a CD) set in drive unit 46, a program (hereinafter referred to as “specific program” for the sake of convenience) corresponding to the processing algorithm of wafer alignment and exposure operation, which is shown in a flowchart (described later), other programs, database that comes with the programs, and the like are stored.

Main controller 20 executes the processing according to the above specific program, for example, so that the exposure operation is precisely performed and controls, for example, the synchronous scanning of reticle R and wafer W, the step movement (stepping) of wafer W, and the like.

More specifically, during scanning exposure for example, main controller 20 controls the position and the speed of reticle stage RST and wafer stage WST, respectively, via the reticle stage drive section (not shown) and the wafer stage drive section 24 through stage controller 19, based on the measurement values of reticle interferometer 16 and wafer interferometer 18, which are obtained via the stage controller 19, so that wafer W is scanned in the −Y direction (or the +Y direction) with respect to a projection area conjugate with the above illumination area at speed V_{W}=βV (β is the projection magnification from reticle R to wafer W) synchronously with reticle R, which is scanned in the +Y direction (or the −Y direction) at speed V_{R}=V via reticle stage RST. Further, during the stepping, main controller 20 controls the position of wafer stage WST via wafer stage control section 24 through stage controller 19 based on the measurement values of wafer interferometer 18.

Furthermore, exposure apparatus 100 of the embodiment is equipped with a multiple point focus detection system by an oblique incident method, consisting of an illumination system (not shown) that supplies image-forming beams in order to form a plurality of slit images toward a best image-forting plane of projection optical system PL from an oblique direction with respect to the optical axis AX, and a light receiving system (not shown) that receives the reflection beams of the image-forming beams at the surface of wafer W via the slits. As the multiple point focus detection system, a system having the same constitution as the one disclosed in Kokai (Japanese Unexamined Patent Application Publication) No. 6-283403 and its corresponding U.S. Pat. No. 5,448,332 or the like is used, and output from the multiple point focus detection system is supplied to main controller 20. As long as the national laws in designated states or elected states, to which this international application is applied, permit, the above disclosures of the publication and the U.S. patent are incorporated herein by reference. Main controller 20 drives wafer stage WST in the Z direction and a direction of inclination via stage controller 19 and wafer stage drive section 24, based on the position information of the wafer from the multiple point focus detection system.

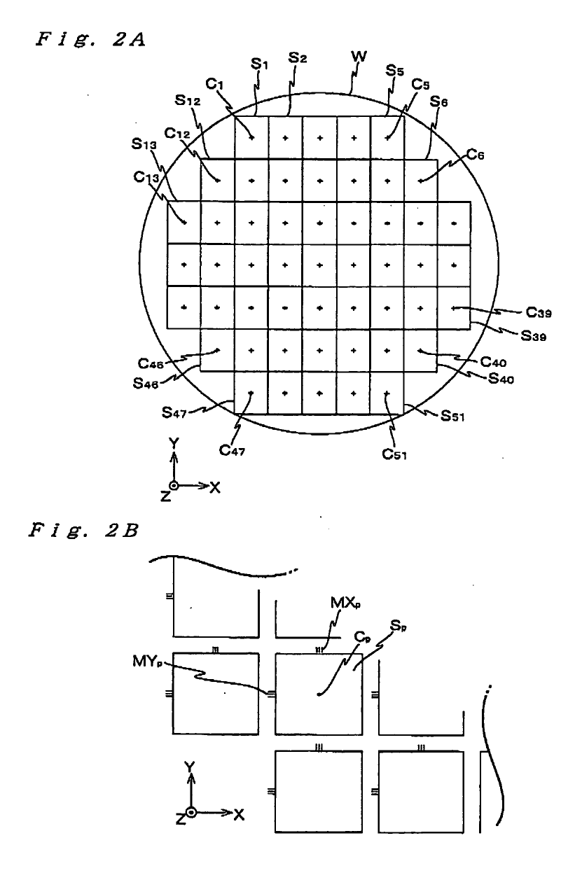

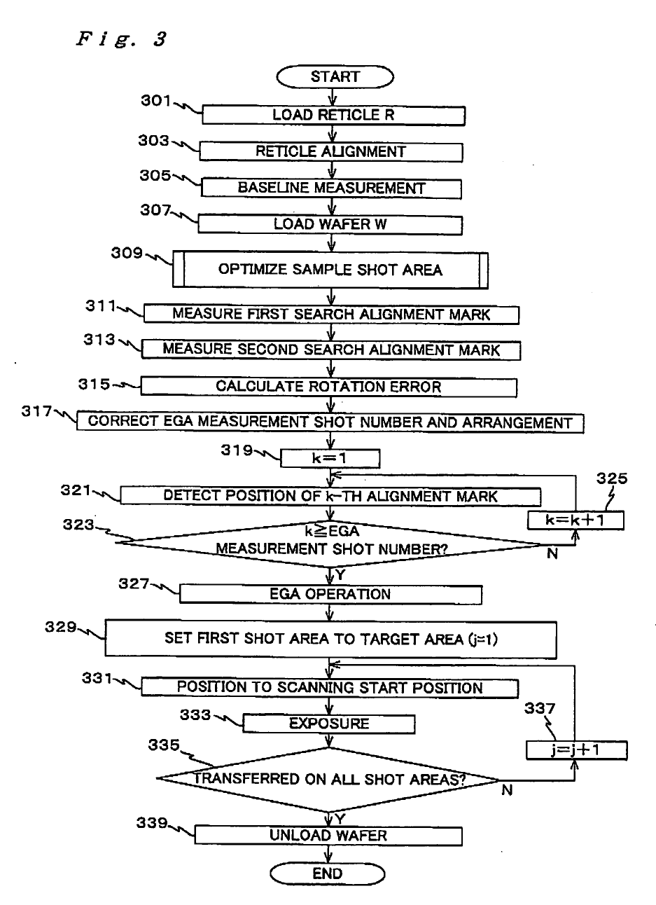

Next, an operation will be described when exposure apparatus 100 of the embodiment, which has the arrangement described above, performs exposure processing on the second layer and the subsequent layers of wafer W. The description will be made referring to FIGS. 2A and 2B, which show the arrangement of shot areas on wafer W, to the flowcharts in FIGS. 3 to 6 that show the processing algorithm of the CPU in main controller 20, which is executed according to the above specific program, and to other drawings as appropriate.

Further, as a premise, the specific program and other programs in the CD-ROM set in drive unit 46 is to be installed in the storage device, and furthermore, programs related to reticle alignment, baseline measurement processing, and the like are to be loaded from the storage device into the main memory by the CPU inside main controller 20.

On wafer W whose second layer and the layer onward are subject to exposure, as is shown in FIG. 2A, 51 shot areas Sₚ (p=1 to 51) are arranged in the shape of a matrix in the processing step of the previous layer. Moreover, as is shown in FIG. 2B, together with the shot areas Sₚ, a wafer alignment X mark (wafer X mark) MXₚ and a wafer alignment Y mark (wafer Y mark) MYₚ are severally formed on street lines of a predetermined width (e.g., the width of about 100 μm) between adjacent shot areas. Of these marks, the X position of wafer X mark MXₚ matches the X coordinate (the center Cₚ) of shot area Sₚ designwise, and the Y position of wafer Y mark MYₚ matches the Y coordinate (the center Cₚ) of shot area Sₚ designwise. In other words, the position coordinate (the center Cₚ) of shot area Sₚ can be obtained, designwise, from the X position of wafer X mark MXₚ and the Y position of wafer Y mark MYₚ. Meanwhile, in the embodiment, optimization is actually performed on the number and the arrangement of marks MXₚ and MYₚ serving as the area subject to measurement, and on the movement sequence when measurement is performed by alignment detection system AS, however, because the position of the marks are also the position of shot areas Sₚ, the optimization is substantially equal to performing optimization on the number and the arrangement of shot area Sₚ, and on the movement sequence in between shots. Accordingly, the following description will be made as if optimization is performed on the number and the arrangement of shot areas where the measurement marks are arranged, and on the movement sequence (regarding the movement sequence, although the movement sequence will slightly change depending on whether wafer X mark MXₚ or wafer Y mark MYₚ is measured first, in the embodiment, for the sake of simplicity, optimization is to be performed only for the movement sequence in between shot areas).

In this case, as wafer X mark MXₚ, for example, a line-and-space mark having a periodic direction in the X-axis direction is used, and for example, a line-and-space mark having a periodic direction in the Y-axis direction is used as wafer Y mark MYₚ. As these marks, for example, a mark having three line patterns is used, however, the line patterns may be of any number. Further, the number of shot areas on wafer W is not limited to 51.

Furthermore, although it is not shown in FIG. 2B, in each shot area Sp, other than wafer marks MXₚ and MYₚ shown in FIG. 2B, marks used for search alignment (to be described later) (search alignment marks) are also to be arranged.

Information related to the shot areas on wafer W or the like described above is to be stored in the storage device.

As is shown in FIG. 3, first of all, in step 301, reticle R is loaded on reticle stage RST by a reticle loader (not shown). When the reticle loading is completed, in steps 303→305→307, main controller 20 (more precisely, the CPU) executes reticle alignment, baseline measurement, and wafer load according to the above programs of reticle alignment, baseline measurement, and wafer load processing in the following manner.

More specifically, main controller 20 positions fiducial mark plate FM on wafer stage WST at a predetermined position directly under projection optical system PL (hereinafter, referred to as “reference position” for the sake of convenience) via wafer stage drive section 24, and detects the positional relation of a pair of marks (a first fiducial mark) on fiducial mark plate FM and a pair of reticle alignment marks on reticle R corresponding to the first fiducial mark, using the above pair of reticle alignment detection systems 22. Then, main controller 20 stores the detection results of reticle alignment detection systems 22 and the measurement values of interferometers 16 and 18 at the point of detection obtained via stage controller 19 into the main memory. Next, main controller 20 moves wafer stage WST and reticle stage RST in directions opposite to each other only by a predetermined distance along the Y-axis direction, and detects the positional relation of a different pair of the first fiducial marks on fiducial mark plate FM and a different pair of reticle alignment marks on reticle R, using the pair of reticle alignment detection systems 22 described above. Then, main controller 20 stores the detection results of reticle alignment detection systems 22 and the measurement values of interferometers 16 and 18 at the point of detection obtained via stage controller 19 into the main memory. Subsequently, in the same manner as in the description above, the positional relation between another different pair of the first fiducial marks on fiducial mark plate FM and the reticle alignment marks corresponding to the first fiducial marks may be further measured.

Then, the main controller 20 obtains the positional relation between the reticle stage coordinate system set by the measurement axis of interferometer 16 and the wafer stage coordinate system set by the measurement axis of interferometer 18. The position relation is obtained using the information on the positional relation of at least the two pairs of the first fiducial marks and the corresponding reticle alignment marks obtained in the manner described above, and the measurement values of interferometers 16 and 18 at the point of measurement. And with this operation, reticle alignment is completed.

Next, in step 305, main controller 20 performs baseline measurement. More specifically, main controller 20 returns wafer stage WST to the above reference position, and then moves wafer stage WST from the reference position by a predetermined amount (e.g., the design value of the baseline) within the XY plane to detect a second fiducial mark on fiducial mark plate FM using alignment detection system AS (the measurement values of wafer interferometer 18 is stored in the main memory via stage controller 19). Then, main controller 20 calculates the baseline of alignment detection system AS, that is, the distance (positional relation) between the projection center of the reticle pattern and the detection center (index center) of alignment detection system AS, based on the information on the positional relation between the detection center of alignment detection system AS and the second fiducial marks, which is obtained at this point and the information on the positional relation between the pair of the first fiducial marks that have been measured when wafer stage WST was positioned at the reference position earlier and the pair of reticle alignment marks corresponding to the first fiducial marks, the measurement value of wafer interferometer 18 at each point of measurement, and the positional relation between the first fiducial marks and the second fiducial marks, which are already known.

Then, in step 307, main controller 20 gives instructions to the control system of a wafer loader (not shown) to load wafer W. Accordingly, the wafer loader loads wafer W onto wafer holder 25 on wafer stage WST. In the embodiment, prior to the loading of wafer W, a pre-alignment unit (not shown) is to roughly adjust the rotational deviation and the center position deviation of wafer W to wafer stage WST so as to make the wafer stage coordinate system that sets the movement position of wafer stage WST (hereinafter, abbreviated as “stage coordinate system”) and the coordinate system set by the shot areas of wafer W (hereinafter, abbreviated as “arrangement coordinate system”) coincide to a certain level. Further, at this point, main controller 20 reads the information related to wafer W stored in the storage device into the main memory.

When the series of preparatory operations are completed, main controller 20 unloads the programs of the above reticle alignment, baseline measurement processing, and the like from the main memory, and loads the above specific program into the main memory. Hereinafter, according to the specific program, the selection method of the embodiment, or more particularly, the optimization of the number and the arrangement of the measurement shot areas in search alignment and wafer alignment and the movement sequence on measurement (which corresponds to the optimization of the number and the arrangement of alignment marks and the movement sequence on measurement, as is described above), search alignment and wafer alignment by the EGA method in a state where the optimization has been performed, and exposure of each shot area on wafer W are performed.

[Principles of Optimization]

Next, in subroutine 309, the optimization is performed on the number and the arrangement of the shot areas that are used for measurement in search alignment and wafer alignment (hereinafter, abbreviated to “EGA measurement shot areas” or “sample measurement shot areas” as appropriate) and on the movement sequence. However, before describing the processing procedures of the optimization, the principles of the optimization algorithm for the number and the arrangement of measurement shot areas will now be described.

In the embodiment, from the total shot areas Sₚ on wafer W (p=1, 2, . . . , 51, although the number of total shots is set to 51 in the embodiment, the number of total shots may also be expressed as m (pieces) for the sake of convenience), n (n is an integer that equals 3 and over) sample measurement shot areas (which are expressed as S′ᵢ (i=1, 2, . . . , n)) are selected using an optimization processing that will be described later. And, when the design arrangement coordinate of the selected sample measurement shot areas S′ᵢ is expressed as (xᵢ, yᵢ), a linear model of deviation (dxᵢ, dyᵢ) from the design arrangement coordinate can be presumed by the following expression.

$$( \begin{matrix}{dx}_{i} \\ {dy}_{i}\end{matrix} ) = ( \begin{matrix}{S}_{x} {x}_{i} + {R}_{x} {y}_{i} + {O}_{x} \\ {R}_{y} {x}_{i} + {S}_{y} {y}_{i} + {O}_{y}\end{matrix} ) \qquad ( 1 )$$

In this case, Sₓ, S_{y}, Rₓ, R_{y}, Oₓ and O_{y} show six error parameters related to the alignment by the EGA method. More specifically, Sₓ and S_{y} show the linear expansion/contraction (scaling) of the wafer in the X-axis and Y-axis directions, Rₓ and R_{y} show the rotation amount (rotation) of the X-axis and the Y-axis, and Oₓ and O_{y} show the offsets in the X-axis direction and the Y-axis direction.

When deviation (measurement value) of each of the n sample measurement shot areas from the design arrangement coordinate (xᵢ, yᵢ) is expressed as (Δxᵢ, Δyᵢ), the sum of squares x² of the residual between this deviation and the deviation from the design arrangement coordinate presumed in the above linear model can be expressed as in the following expression.

$${χ}^{2} = {\sum }_{i = 1}^{n} [ {\{ \frac{Δ {x}_{i} - ( {S}_{x} {x}_{i} + {R}_{x} {y}_{i} + {O}_{x} )}{{σ}_{{x}_{i}}} \}}^{2} + {\{ \frac{Δ {y}_{i} - ( {R}_{y} {x}_{i} + {S}_{y} {y}_{i} + {O}_{y} )}{{σ}_{{y}_{i}}} \}}^{2} ] \qquad ( 2 )$$

In this case, σₓᵢ and σ_{yi} are errors included in (Δxᵢ, Δyᵢ), and x² is the evaluation function when performing wafer alignment by the EGA method (to be described later) In the EGA method, error parameters (Sₓ, S_{y}, Rₓ, R_{y}, Oₓ, O_{y}) that minimize evaluation function x² are obtained by a statistical calculation such as the least-squares method. In this case, the following expression can be obtained as a condition for minimizing evaluation function x².

$$\frac{\partial {χ}^{2}}{\partial {S}_{x}} = \frac{\partial {χ}^{2}}{\partial {S}_{y}} = \frac{\partial {χ}^{2}}{\partial {R}_{x}} = \frac{\partial {χ}^{2}}{\partial {R}_{y}} = \frac{\partial {χ}^{2}}{\partial {O}_{x}} = \frac{\partial {χ}^{2}}{\partial {O}_{y}} = 0 \qquad ( 3 )$$

Accordingly, from the above expression (3), the following expressions (4) and (5) (normal equation) are obtained.

$$\begin{matrix}( \begin{matrix}{\sum }_{i = 1}^{n} \frac{{x}_{i}^{2}}{{σ}_{{x}_{i}}^{2}} & {\sum }_{i = 1}^{n} \frac{{x}_{i} {y}_{i}}{{σ}_{{x}_{i}}^{2}} & {\sum }_{i = 1}^{n} \frac{{x}_{i}}{{σ}_{{x}_{i}}^{2}} \\ {\sum }_{i = 1}^{n} \frac{{x}_{i} {y}_{i}}{{σ}_{{x}_{i}}^{2}} & {\sum }_{i = 1}^{n} \frac{{y}_{i}^{2}}{{σ}_{{x}_{i}}^{2}} & {\sum }_{i = 1}^{n} \frac{{y}_{i}}{{σ}_{{x}_{i}}^{2}} \\ {\sum }_{i = 1}^{n} \frac{{x}_{i}}{{σ}_{{x}_{i}}^{2}} & {\sum }_{i = 1}^{n} \frac{{y}_{i}}{{σ}_{{x}_{i}}^{2}} & {\sum }_{i = 1}^{n} \frac{1}{{σ}_{{x}_{i}}^{2}}\end{matrix} ) ( \begin{matrix}{S}_{x} \\ {R}_{x} \\ {O}_{x}\end{matrix} ) ( \begin{matrix}{\sum }_{i = 1}^{n} \frac{Δ {x}_{i} {x}_{i}}{{σ}_{{x}_{i}}^{2}} \\ {\sum }_{i = 1}^{n} \frac{Δ {x}_{i} {y}_{i}}{{σ}_{{x}_{i}}^{2}} \\ {\sum }_{i = 1}^{n} \frac{Δ {x}_{i}}{{σ}_{{x}_{i}}^{2}}\end{matrix} ) & ( 4 ) \\ ( \begin{matrix}{\sum }_{i = 1}^{n} \frac{{x}_{i}^{2}}{{σ}_{{y}_{i}}^{2}} & {\sum }_{i = 1}^{n} \frac{{x}_{i} {y}_{i}}{{σ}_{{y}_{i}}^{2}} & {\sum }_{i = 1}^{n} \frac{{x}_{i}}{{σ}_{{y}_{i}}^{2}} \\ {\sum }_{i = 1}^{n} \frac{{x}_{i} {y}_{i}}{{σ}_{{y}_{i}}^{2}} & {\sum }_{i = 1}^{n} \frac{{y}_{i}^{2}}{{σ}_{{y}_{i}}^{2}} & {\sum }_{i = 1}^{n} \frac{{y}_{i}}{{σ}_{{y}_{i}}^{2}} \\ {\sum }_{i = 1}^{n} \frac{{x}_{i}}{{σ}_{{y}_{i}}^{2}} & {\sum }_{i = 1}^{n} \frac{{y}_{i}}{{σ}_{{y}_{i}}^{2}} & {\sum }_{i = 1}^{n} \frac{1}{{σ}_{{y}_{i}}^{2}}\end{matrix} ) ( \begin{matrix}{R}_{y} \\ {S}_{y} \\ {O}_{y}\end{matrix} ) ( \begin{matrix}{\sum }_{i = 1}^{n} \frac{Δ {y}_{i} {x}_{i}}{{σ}_{{y}_{i}}^{2}} \\ {\sum }_{i = 1}^{n} \frac{Δ {y}_{i} {y}_{i}}{{σ}_{{y}_{i}}^{2}} \\ {\sum }_{i = 1}^{n} \frac{Δ {y}_{i}}{{σ}_{{y}_{i}}^{2}}\end{matrix} ) & ( 5 )\end{matrix}$$

Then, by solving the above expressions (4) and (5), the maximum likelihood estimate is obtained for the six error parameters (Sₓ, S_{y}, Rₓ, R_{y}, Oₓ, O_{y}) shown below.
(Ŝₓ,Ŝ_{y},\hat{R}ₓ,\hat{R}_{y},Ôₓ,Ô_{y})

In this case, when (Sₓ, S_{y}, Rₓ, R_{y}, Oₓ, O_{y}) in the above expression (1) is replaced by the above maximum likelihood estimates, and the arrangement coordinates (xₚ, Yₚ) of all the shot areas Sₚ (p=1 to 51) are substituted severally in the above-described expression (1), a correction value shown below of shot area Sₚ can be decided.
(d\hat{x}ₚ,dŷₚ)

Further, the errors that each of the above maximum likelihood estimates have can be defined as follows.
(\hat{σ}_{S}_{ₓ},\hat{σ}_{S}_{_{y}},\hat{σ}_{R}_{ₓ},\hat{σ}_{R}_{_{y}},\hat{σ}_{O}_{ₓ},\hat{σ}_{O}_{_{y}})

Since the error that each above maximum likelihood estimate has is a square root of a diagonal element of an inverse matrix of the 3×3 matrix on the left side of the above expressions (4) and (5), the following expression can be obtained.

$$\begin{matrix}{\hat{σ}}_{{S}_{x}}^{2} = \frac{1}{\vert {A}_{x} \vert} \{ {\sum }_{i = 1}^{n} \frac{{y}_{i}^{2}}{{σ}_{{x}_{i}}^{2}} {\sum }_{i = 1}^{n} \frac{1}{{σ}_{{x}_{i}}^{2}} - {( {\sum }_{i = 1}^{n} \frac{{y}_{i}}{{σ}_{{x}_{i}}^{2}} )}^{2} \} \\ {\hat{σ}}_{{R}_{x}}^{2} = \frac{1}{\vert {A}_{x} \vert} \{ {\sum }_{i = 1}^{n} \frac{{x}_{i}^{2}}{{σ}_{{x}_{i}}^{2}} {\sum }_{i = 1}^{n} \frac{1}{{σ}_{{x}_{i}}^{2}} - {( {\sum }_{i = 1}^{n} \frac{{x}_{i}}{{σ}_{{x}_{i}}^{2}} )}^{2} \} \\ {\hat{σ}}_{{O}_{x}}^{2} = \frac{1}{\vert {A}_{x} \vert} \{ {\sum }_{i = 1}^{n} \frac{{x}_{i}^{2}}{{σ}_{{x}_{i}}^{2}} {\sum }_{i = 1}^{n} \frac{{y}_{i}^{2}}{{σ}_{{x}_{i}}^{2}} - {( {\sum }_{i = 1}^{n} \frac{{x}_{i} {y}_{i}}{{σ}_{{x}_{i}}^{2}} )}^{2} \} \\ {\hat{σ}}_{{R}_{y}}^{2} = \frac{1}{\vert {A}_{y} \vert} \{ {\sum }_{i = 1}^{n} \frac{{y}_{i}^{2}}{{σ}_{{y}_{i}}^{2}} {\sum }_{i = 1}^{n} \frac{1}{{σ}_{{y}_{i}}^{2}} - {( {\sum }_{i = 1}^{n} \frac{{y}_{i}}{{σ}_{{y}_{i}}^{2}} )}^{2} \} \\ {\hat{σ}}_{{S}_{y}}^{2} = \frac{1}{\vert {A}_{y} \vert} \{ {\sum }_{i = 1}^{n} \frac{{x}_{i}^{2}}{{σ}_{{y}_{i}}^{2}} {\sum }_{i = 1}^{n} \frac{1}{{σ}_{{y}_{i}}^{2}} - {( {\sum }_{i = 1}^{n} \frac{{x}_{i}}{{σ}_{{y}_{i}}^{2}} )}^{2} \} \\ {\hat{σ}}_{{O}_{y}}^{2} = \frac{1}{\vert {A}_{y} \vert} \{ {\sum }_{i = 1}^{n} \frac{{x}_{i}^{2}}{{σ}_{{y}_{i}}^{2}} {\sum }_{i = 1}^{n} \frac{{y}_{i}^{2}}{{σ}_{{y}_{i}}^{2}} - {( {\sum }_{i = 1}^{n} \frac{{x}_{i} {y}_{i}}{{σ}_{{y}_{i}}^{2}} )}^{2} \}\end{matrix} \} \qquad ( 6 )$$

However, |Aₓ| and |A_{y}| in the above expression (6) can be expressed as in the following expression.

$$\begin{matrix}\begin{matrix}\vert {A}_{x} \vert = {\sum }_{i = 1}^{n} \frac{{x}_{i}^{2}}{{σ}_{{x}_{1}}^{2}} {\sum }_{i = 1}^{n} \frac{{y}_{i}^{2}}{{σ}_{{x}_{1}}^{2}} {\sum }_{i = 1}^{n} \frac{1}{{σ}_{{x}_{i}}^{2}} + 2 {\sum }_{i = 1}^{n} \frac{{x}_{i} {y}_{i}}{{σ}_{{x}_{1}}^{2}} {\sum }_{i = 1}^{n} \frac{{x}_{i}}{{σ}_{{x}_{1}}^{2}} {\sum }_{i = 1}^{n} \frac{{y}_{i}}{{σ}_{{x}_{i}}^{2}} - \\ {( {\sum }_{i = 1}^{n} \frac{{x}_{i }}{{σ}_{{x}_{1}}^{2}} )}^{2} {\sum }_{i = 1}^{n} \frac{{y}_{i}^{2}}{{σ}_{{x}_{i}}^{2}} - {\sum }_{i = 1}^{n} \frac{{x}_{i}^{2}}{{σ}_{{x}_{i}}^{2}} {( {\sum }_{i = 1}^{n} \frac{{y}_{i}}{{σ}_{{x}_{i}}^{2}} )}^{2} - \\ {( {\sum }_{i = 1}^{n} \frac{{x}_{i } {y}_{i}}{{σ}_{{x}_{1}}^{2}} )}^{2} {\sum }_{i = 1}^{n} \frac{1}{{σ}_{{x}_{i}}^{2}}\end{matrix} \\ \begin{matrix}\vert {A}_{y} \vert = {\sum }_{i = 1}^{n} \frac{{x}_{i}^{2}}{{σ}_{{y}_{1}}^{2}} {\sum }_{i = 1}^{n} \frac{{y}_{i}^{2}}{{σ}_{{y}_{1}}^{2}} {\sum }_{i = 1}^{n} \frac{1}{{σ}_{{y}_{i}}^{2}} + 2 {\sum }_{i = 1}^{n} \frac{{x}_{i} {y}_{i}}{{σ}_{{y}_{1}}^{2}} {\sum }_{i = 1}^{n} \frac{{x}_{i}}{{σ}_{{y}_{1}}^{2}} {\sum }_{i = 1}^{n} \frac{{y}_{i}}{{σ}_{{y}_{i}}^{2}} - \\ {( {\sum }_{i = 1}^{n} \frac{{x}_{i }}{{σ}_{{y}_{1}}^{2}} )}^{2} {\sum }_{i = 1}^{n} \frac{{y}_{i}^{2}}{{σ}_{{y}_{i}}^{2}} - {\sum }_{i = 1}^{n} \frac{{x}_{i}^{2}}{{σ}_{{y}_{i}}^{2}} {( {\sum }_{i = 1}^{n} \frac{{y}_{i}}{{σ}_{{y}_{i}}^{2}} )}^{2} - \\ {( {\sum }_{i = 1}^{n} \frac{{x}_{i } {y}_{i}}{{σ}_{{y}_{1}}^{2}} )}^{2} {\sum }_{i = 1}^{n} \frac{1}{{σ}_{{y}_{i}}^{2}}\end{matrix}\end{matrix} \} \qquad ( 7 )$$

As is described above, the maximum likelihood estimate of the position deviation amount of the shot design position (xₚ, yₚ) from the design arrangement coordinate, which can be expressed as follows:
(d\hat{x}ₚ,dŷₚ)
   can be computed based on the above expression (1), and the overlay error that the maximum likelihood estimate has, which can be expressed as follows:
(\hat{σ}_{dx}_{ₚ},\hat{σ}_{dy}_{ₚ})
can be calculated from the following expression.

$$\begin{matrix}{\hat{σ}}_{{dx}_{p}}^{2} = {x}_{p}^{2} {\hat{σ}}_{{S}_{x}}^{2} + {y}_{p}^{2} {\hat{σ}}_{{R}_{x}}^{2} + {\hat{σ}}_{{O}_{x}}^{2} \\ {\hat{σ}}_{{dy}_{p}}^{2} = {x}_{p}^{2} {\hat{σ}}_{{R}_{y}}^{2} + {y}_{p}^{2} {\hat{σ}}_{{S}_{y}}^{2} + {\hat{σ}}_{{O}_{y}}^{2}\end{matrix} \} \qquad ( 8 )$$

Accordingly, when the expected value of the overlay error of all the shot areas (total shot number m) is expressed as follows:
(μ_{\hat{σ}}_{_{dx}}_{²},μ_{\hat{σ}}_{_{dy}}_{²})
   and the sample variance expressed as follows:
(S_{\hat{σ}}_{_{dx}}_{²}²,S_{\hat{σ}}_{_{dy}}_{²}²)
they can be expressed as in the following expressions (9) and (10).

$$\begin{matrix}\begin{matrix}{μ}_{{\hat{σ}}_{dx}^{2}} = \frac{1}{m} {\sum }_{p = 1}^{m} {\hat{σ}}_{{dx}_{p}}^{2} \\ {μ}_{{\hat{σ}}_{dy}^{2}} = \frac{1}{m} {\sum }_{p = 1}^{m} {\hat{σ}}_{{dy}_{p}}^{2}\end{matrix} \} & ( 9 ) \\ \begin{matrix}{S}_{{\hat{σ}}_{dx}^{2}} = \frac{{\sum }_{p = 1}^{m} {( {\hat{σ}}_{{dx}_{p}^{2}} - {μ}_{{\hat{σ}}_{dx}^{2}} )}^{2}}{m - 1} \\ {S}_{{\hat{σ}}_{dy}^{2}} = \frac{{\sum }_{p = 1}^{m} {( {\hat{σ}}_{{dy}_{p}}^{2} - {μ}_{{\hat{σ}}_{dy}^{2}} )}^{2}}{m - 1}\end{matrix} \} & ( 10 )\end{matrix}$$

As is described above, by using the above expressions (4), (5), and (6), the maximum likelihood estimates of the error parameters in the case n shot areas (expressed as S′ᵢ (i=1, 2, . . . , n)) are selected as choices for the sample measurement shot area from all the shot areas Sₚ and the errors included in the maximum likelihood estimates of the error parameters can be estimated. And then, based on the errors, the expected value of the overlay error in all the shot areas Sₚ and the sample variance (expression (9) and expression (10)) when the sample measurement shot areas are selected can be estimated. Therefore, in the optimization processing of the sample measurement shot area in subroutine 309 (to be described later), the expected value of the overlay error in all the shot areas and the sample variance value severally shown in expression (9) and expression (10) are obtained for a set of the selected sample measurement shot area, and based on the values, the shot areas included in a subset of the set are judged whether or not the shot areas included in the subset should be used as the combination of shot areas that will be measured during wafer alignment.

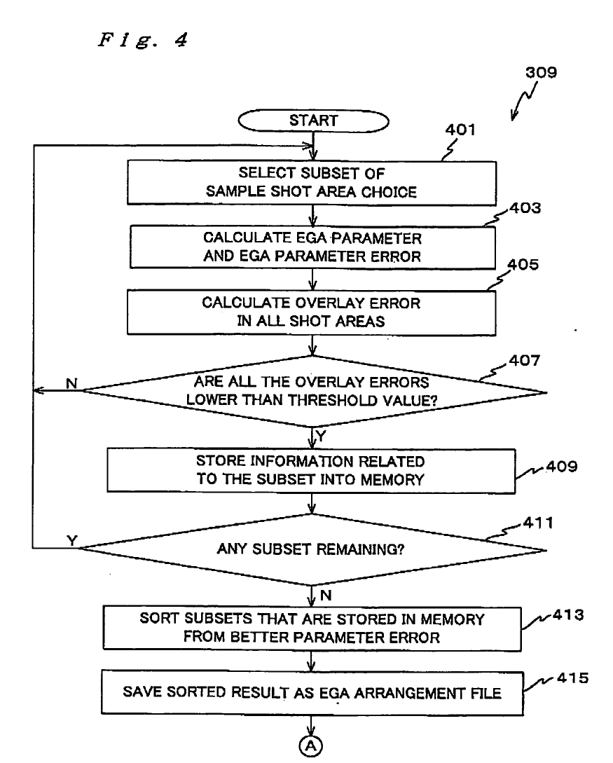

FIG. 4 shows a flowchart of the processing in subroutine 309. As is shown in FIG. 4, in step 401, selecting of a subset of the sample measurement shot area is performed. The subset of the sample measurement shot area refers to a set of selected shot areas when several shot areas are arbitrarily selected as a choice of the sample measurement shot area from the elements of a total set, in the case the overall sets of all the shot areas is expressed as a total set. In short, the subset of the sample measurement shot area refers to the combination of the sample measurement shot area choices.

For example, when the number of sample measurement shots is n, because the number of all the shots is m (=51) in the embodiment, a total of ₅₁Cₙ subsets having n sample shot measurement areas can be made from all the shot areas. In this case, one subset will be selected from the subsets of the sample measurement shot area made in the manner described above. In the embodiment, because the optimization of the number of sample measurement shots is also performed, (₅₁Cₙ₁+₅₁Cₙ₁₊₁+₅₁C_{n1+2 . . . 51}Cₙ₂) subsets are made by incrementing the number of sample measurement shots n by 1, from the minimum value (expressed as n1) to the maximum value (expressed as n2(>n1)), and from all the subsets that has been made, a sub-set is calculated. At this point, because there is no selected subset yet, an arbitrary subset can be selected from the all subsets formed. However, as it will be described later, when the selecting of the subset is to be executed again returning to this step 401 after the judgment is negative in step 407 or the judgment turns positive in step 411, a subset that has not yet been selected should be selected from the subsets that have been made. The above values such as n1 and n2 are stored in the storage device as unit parameters, and the values are to be read into the main memory at the point when step 401 is executed.

In the embodiment, although the number of sample measurement shots n is also optimized, it is naturally possible to fix the number of sample measurement shots n to 8, for example, and optimize only the arrangement. In this case, in step 401, only one subset should be selected from ₅₁Cₙ subsets.

In the next step, step 403, an EGA parameter and an error of the EGA parameter are calculated. More specifically, the above expressions (4) and (5) are calculated, based on the design value (xᵢ, yᵢ) of the shot area included in the subset selected in step 401 and an error (σₓᵢ, σ_{yi}) of the deviation amount with respect to the mark design position of the shot area, and the maximum likelihood estimates of the error parameters:
(Ŝₓ,Ŝ_{y},\hat{R}ₓ,\hat{R}_{y},Ôₓ,Ô_{y})
   are calculated. The error (σₓᵢ, σ_{yi}) values of the deviation amount serving as a predetermined accuracy index corresponding to the design values of all the shot areas are calculated in advance, and are to be stored in the storage unit as the above information related to wafer W. As the error of the deviation amount, for example, an index relative to measurement reproducibility, which is related to the position information of the shot areas can be used. As such accuracy index, two types of values, that is, a target value and an ability value (a value having a slight margin to the target value) of alignment in exposure apparatus 100 can be considered. Further, as measurement reproducibility, the measurement reproducibility with respect to individual alignment marks and the reproducibility of overlay results can be considered.

Furthermore, the main controller 20 obtains the estimated value of the error of the above maximum likelihood estimates using the above expression (6).
(\hat{σ}_{S}_{ₓ},\hat{σ}_{S}_{_{y}},\hat{σ}_{R}_{ₓ},\hat{σ}_{R}_{_{y}},\hat{σ}_{O}_{ₓ},\hat{σ}_{O}_{_{y}})

In the next step, step 405, the above-described expression (8) is calculated for each shot area to calculate the overlay error of each shot area, in all the shot areas. Then, the expected value and the sample variance of the overlay errors of all the shot areas are calculated using the above expressions (9) and (10).

In the next step, step 407, the judgment is made of whether or not the expected values and the sample variance of the overlay errors of all the shot areas obtained from the above expressions (9) and (10) are all lower than a predetermined threshold value (a favorable case, in this case, is when the values of expected value and sample variance are small, because the overlay errors become smaller when the values decrease). When the judgment is positive, the processing then proceeds to step 409, whereas when the judgment is negative, the processing returns to step 401. In this case, the processing is to return to step 401 on the assumption that the judgment is negative. The threshold value can naturally be set to a different value according to each calculation result obtained by expressions (9) and (10), and the threshold value is to be stored in advance in the storage device as a unit parameter and is to be loaded in the main memory at this point. Further, in step 407, a judgment condition of whether or not the error of the error parameter calculated by expression (6) is lower than the predetermined threshold value may be employed.

Hereinafter, until the judgment turns positive in step 407, a subset of the sample measurement shots is selected in step 401, and the processing of steps 403→405→407 is repeatedly performed.

In step 407, when the calculation results of expressions (9) and (10), that is, all the expected values and the values of sample variance of the overlay error in all the shot areas are lower than a predetermined threshold value, the processing then proceeds to step 409.

In the next step, step 409, information on a selected subset, that is, information such as the position of shot area Sᵢ included in the subset is stored in the main memory. Then, in step 411, a judgment is made of whether or not there are any remaining subsets whose EGA parameter error and overlay error are not estimated yet in the subsets that have been made. In the case the judgment turns positive, the processing returns to step 401, while when the judgment is negative, the processing proceeds to step 413.

Hereinafter, in step 411, processing of steps 401→403→405→407 is repeatedly performed until the EGA parameter, the EGA parameter error, the overlay error and the like are calculated for all the subsets and there are no remaining subsets. And, when it is judged that all overlay errors in the selected subset are lower than the threshold value in step 407, then, in step 409, information on the selected subset is stored in the main memory.

When EGA parameter, EGA parameter error, overlay error and the like are calculated for all the subsets that have been made, and the judgment is negative in step 411, the processing proceeds to step 413. In step 413, subsets that are to be stored in the main memory (that is, information related to the subsets) are sorted by the overlay error in a descending order, and in step 415, the results of the sorting is saved in the storage unit as an EGA arrangement file.

The subsets of the shot areas included in the EGA arrangement file saved in the storage unit are subsets whose expected values of the overlay error and sample variances in all shot areas calculated in step 405 are better than predetermined threshold values. That is, the subsets included in the EGA arrangement file are (potential) choices of a combination of sample measurement shot areas.

Meanwhile, in step 407, in the case the judgment was not positive for all the subsets, various countermeasures can be taken. For example, the processing in subroutine 309 may be terminated, and then the following processing may be performed (in this case, shot areas that are experientially selected are employed as the EGA measurement shot area), or the threshold value may be changed and the judgment in step 407 may be performed again. Or alternatively, the subsets may be selected again by changing the condition such as the number of sample measurement shots. Further, at least one subset whose values of the calculation results of expressions (9) and (10) are small may be selected in an ascending order, and then the processing may proceed to step 409 where the information on the selected subsets are to be stored in the main memory.

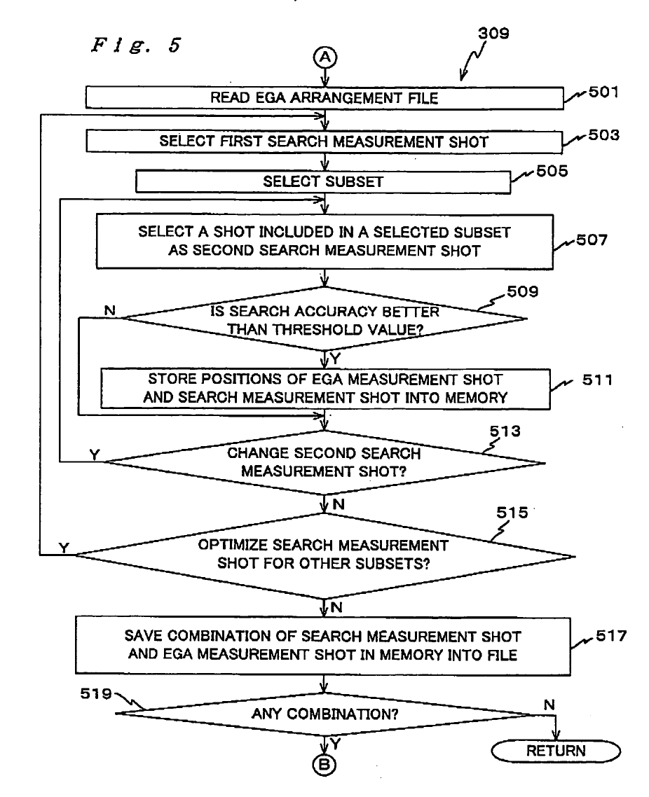

Proceeding to step 501 in FIG. 5, in step 501, the EGA arrangement file stored in the storage unit is read into the main memory. Then, on and after step 503, optimization of the arrangement of the shot areas for search alignment (to be described later) (hereinafter, abbreviated to “search measurement shot areas”) is performed.

In the embodiment, as it will be described later, search alignment is performed before wafer alignment by the EGA method. The search alignment is a processing for grasping the rotation error between the stage coordinate system and the arrangement coordinate system in advance before measuring the alignment marks of the EGA measurement shots, so that the alignment marks are within the detection field of the alignment sensor when measuring the alignment marks with alignment detection system AS. In search alignment, in order to detect the rotation error between the stage coordinate system and the arrangement coordinate system, at least two search alignment marks formed on wafer W are measured.

On wafer W shown in FIGS. 2A and 2B, search alignment marks are also arranged in each shot area Sₚ, in addition to the alignment marks as is previously described. In the embodiment, at least two search alignment marks optimum for performing search alignment are selected from the search alignment marks arranged in each shot area Sₚ.

Firstly, in step 503, the first search measurement shot area is selected. The first search measurement shot area can be selected from all the shot areas on wafer W, and does not have to be selected from the shot areas included in the subsets registered in the EGA arrangement file.

In the next step, step 505, one subset registered in the EGA arrangement file is selected, and in step 507, a second search measurement shot area is selected from the shot areas included in the selected subset. The reason for selecting the second search measurement shot area from the choices of the sample measurement shot areas is because if the second search measurement shot area is the same as a first EGA measurement shot area, the movement distance of the wafer stage when proceeding from search alignment to wafer alignment can be shortened, which is advantageous for throughput.

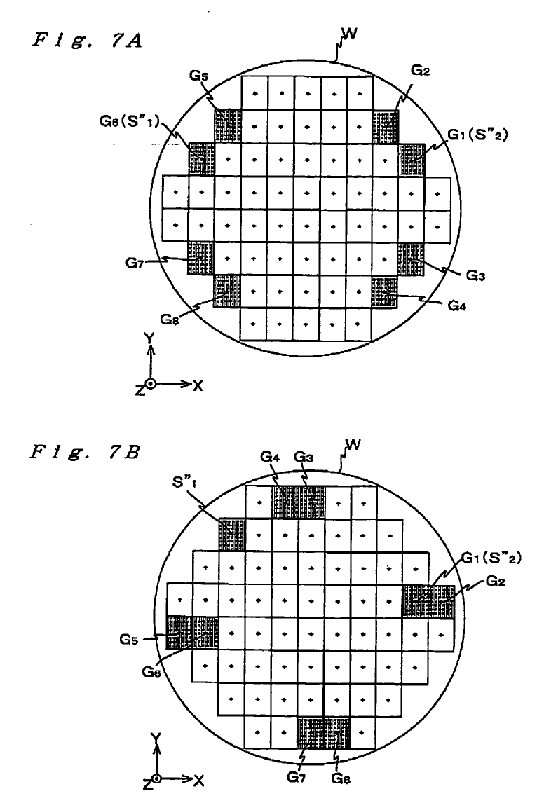

In the next step, step 509, a judgment of whether or not the search alignment accuracy by the selected two shot areas is better than a predetermined threshold value (the threshold value is also to be stored in advance in the storage unit as a unit parameter, and is to be read into the main memory at this point) is made, and when the judgment is positive, then the processing proceeds to step 511, whereas, when the judgment is negative, the processing proceeds to step 513. As a scale of the search alignment accuracy, for example, the distance between the shot area selected as the first search measurement shot area and the shot area selected as the second search measurement shot area can be used. More specifically, in this case, the judgment is made of whether or not both shot areas selected as the search measurement shot areas are arranged a predetermined distance (which is the threshold value (selecting criterion (search span)) apart. Other than the selecting criterion, there are no restrictions regarding the arrangement state of the search measurement shot areas, and the two search measurement shot areas may be arranged apart in the Y-axis direction, may be arranged apart in the X-axis directions, or may be arranged apart in a diagonal direction. For example, shot areas S″₁ and S″₂ shown in FIG. 7A may be selected as the search measurement shot areas, or shot areas G₃ and G₇ shown in FIG. 7B may be selected.

It is desirable to vary the predetermined distance (selecting criterion) according to the wafer size, instead of fixing the predetermined distance regardless of the wafer size. For example, the selecting criterion applied to a 200 mm wafer may be 60 mm, and the selecting criterion applied to a 300 mm wafer may be 100 mm. The main controller 20 may switch the selecting criterion, based on the information on wafer W read into the main memory.

Further, in step 509, the search alignment accuracy does not necessarily have to be used as the selecting criterion, and, for example, importance may be put on measurement throughput and shot areas advantageous for improving throughput may be selected. For example, the movement time of wafer stage WST (or total movement time required for alignment measurement including search alignment and wafer alignment) may be used as the selecting criterion.

When the judgment in step 509 is positive, the processing proceeds to step 511 where the selected two shot areas are regarded as the search measurement shot areas, and information on the search measurement shot areas and the sample measurement shot areas included in the subset that has been selected in step 505 (e.g., position information of the shot areas) is stored in the main memory.

After step 511 is executed, or when the judgment in step 509 is negative, the processing proceeds to step 513 where the judgment is made whether or not the second search measurement shot area should be changed. When the judgment is positive, then the processing returns to step 507, whereas when the judgment is negative, the processing proceeds to step 515. In this case, various types of judgment criterion can be used. For example, the judgment in step 513 may remain positive until step 511 is executed for a predetermined number of times or until all the shot areas included in one subset are selected as the second search measurement shot area. In this case, the description below will be made on the assumption that the judgment is positive.

Hereinafter, in step 513, steps 507→509→511 (this step may not be executed, depending on the judgment in step 509 as is previously described)→513 are repeatedly performed until the judgment turns negative, and the position of the search measurement shot areas whose search accuracy was better than the predetermined threshold value and the EGA measurement shot areas included in the subset at this point are stored in the main memory. In step 507, it goes without saying that a shot area which, has already been selected, should not be selected.

In step 513, when the judgment is negative, the processing proceeds to step 515 where the judgment is made of whether or not the optimization of search measurement shot areas should be performed for other subsets. When the judgment is negative, the processing proceeds to step 517 and when the judgment turns positive, the processing returns to step 503. In this case, the description below will be made on the assumption that the judgment is positive. In this case, as the judgment criterion, for example, whether or not the EGA arrangement file still has a subset whose search measurement shot areas have not been optimized yet, or the like may be used.

Hereinafter, the processing of the above steps 503→505→507→509→511→513→515 is repeatedly performed until the judgment turns negative in step 515, and optimization of the search measurement shot areas is performed on the subset selected in step 505.

In step 515, when the judgment is negative, the processing proceeds to step 517 where the combinations of the search measurement shot areas stored in the main memory in step 511 and the EGA measurement shot areas are stored in the storage unit as a search +EGA measurement shot combination file.

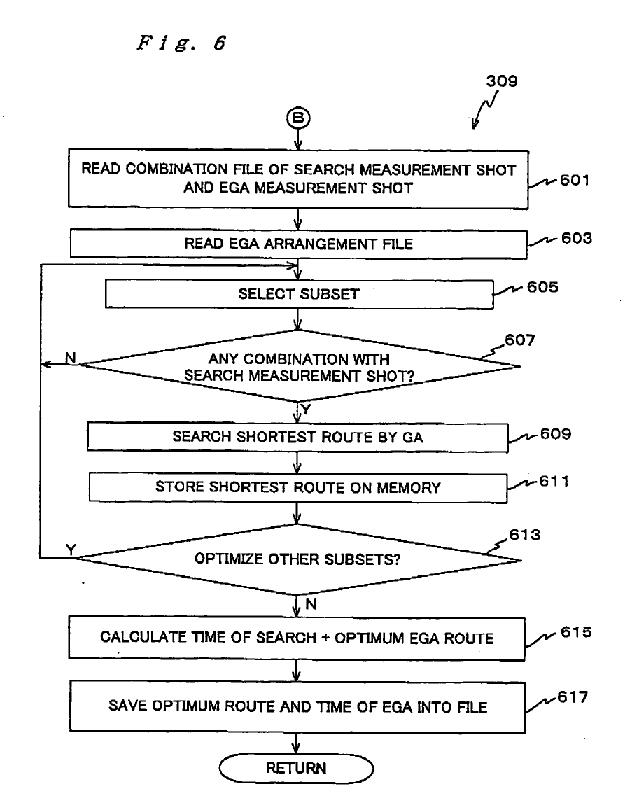

Then, in step 519, the judgment is made of whether or not there is a combination of a search measurement shot area and a sample measurement shot area included in the combination file. In the case it is judged that there is no combination available, the processing in subroutine 309 is terminated, and the processing proceeds to step 311 in FIG. 3. In this case, search alignment and wafer alignment (to be described later) are executed, using the search measurement shot areas and the sample measurement shot areas that have been experientially selected in a conventional manner. In this case, however, the processing proceeds to step 601 in FIG. 6, based on the judgment that a combination is available.

In step 601 in FIG. 6, the combination file of the search measurement shot areas and the EGA measurement shot areas is read from the storage unit into the main memory. Then, in step 603, the EGA arrangement file is also read from the storage unit into the main memory.

In the next step 605, a subset corresponding to the EGA measurement shot areas in the combination file is selected from the EGA arrangement file, and in step 607, the judgment is made of whether or not a combination with the search measurement shot areas exists. When the judgment is positive, the processing proceeds to step 609, and when the judgment is negative, the procedure then returns to step 605. Hereinafter, the processing of steps 605→607 is repeatedly performed until the judgment turns positive in step 607, and a subset having a combination with the search measurement shot areas is selected.

In step 607, when the judgment turns positive, the processing proceeds to step 609 where a search of the shortest path is performed using a genetic algorithm (hereinafter, abbreviated as “GA”), which is an optimization method by evolutionary computation based on the engineering model of the biological evolutionary process. More specifically, the movement sequence (that is, the measurement path of alignment detection system AS) of wafer stage WST on alignment is optimized, using the well-known subtour exchange crossover (SXX), which is one of the solving methods by GA.

In GA, the movement sequence of the EGA measurement shots included in the subset selected in step 605 is modeled into genes. More specifically, for example, when the EGA measurement shot areas included in the subset are shot areas (S₁, S₂, S₅, S₆, S₄₀, S₄₆, S₄₇, S₅₁) on wafer W shown in FIG. 2A, as the movement sequence, for example, an arrangement of S₄₆→S₄₇→S₅₁→S₄₀→S₅→S₂→S₁ is regarded as a genetic arrangement that shows the moving sequence. In GA, first of all, a plurality of genes are made, which are arbitrarily made from the combinations of selected subset shot areas, and these are to be a gene group of the first generation. On the making method of such a gene group of the first generation, for example, a method based on empirical rules, a method based on linear programming, such as the nearest neighbor method (hereinafter referred to as “NN method”), or a solution generated by the solving method of Lin & Kernigham (hereinafter referred to as “LK method”) using a constraint satisfaction solution that has been arbitrarily created as an initial solution, or a solution generated by the LK method, which uses a constraint satisfaction solution generated by a solving method based on the linear programming method (NN method, for example) as an initial solution, or the like may be used. In this case, the total movement time of the movement sequence of the individual genes in the gene group of the first generation is to be severally obtained.

Then, from the gene group, according to a crossover ratio (0.4, for example) that has been set in advance, a crossover operator and a mutation operator makes a gene group that has a different arrangement from the gene group of the first generation. Then, the so-called selection is performed among the gene group of the first generation and the gene group that has been newly made, and superior genes, that is, genes having a shorter movement time in the movement sequence are made to survive dominantly (however, a few genes that are not necessarily superior are also made to survive). More specifically, by repeating the above crossover, mutation, and selection, an optimum solution of the movement sequence, that is, the most preferable movement sequence where the total movement time between the shot areas included in a subset becomes the shortest is obtained, without resulting in a local solution that is not optimum.

Meanwhile, as a generation transition model used in GA, the Elitist model may be used where the superior ones out of all the parents and children are made to survive dominantly. However, an MGG model may be used where all the genes are made into pairs so that none of the genes are left out, and together with the children that are made, the two best genes are passed on to the next generation from each family. Further, as the crossover operator, various kinds of crossover operators used in the solving method of TSP (the so-called traveling salesman problem) can be used, instead of SXX.

Furthermore, in the embodiment, instead of using GA, which is an evolutionary computation, the search for the shortest path may be performed using an operations research like method such as the above linear programming method, LK method, neutral network, and k-OPT method may be used to search the shortest path. Details on the processing such as the GA are disclosed in, for example, Kokai (Japanese Unexamined Patent Application Publication) No. 10-312961 and its corresponding U.S. Patent Application Publication No. 2001053962, Kokai (Japanese Unexamined Patent Application Publication) No. No. 10-303126 and its corresponding U.S. Pat. No. 6,576,919, and the like, accordingly, a detailed description will be omitted. As long as the national laws in designated states or elected states, to which this international application is applied, permit, the disclosures cited above in the above publication and its corresponding U.S. patent are fully incorporated herein by reference.

In the next step, step-611, the shortest path that has been obtained in this manner is stored on the main memory, and in step 613, the judgment is made whether or not the movement sequence of other subsets should be optimized. When the judgment is positive, the processing returns to step 605, and when the judgment is negative, the processing proceeds to step 615. In this case, processing will return to step 605 on the assumption that the judgment is positive. And, in this case, as the judgment criterion, whether or not there still is some subsets left whose movement sequence has not yet been optimized may be used.

Hereinafter, in step 613, a loop processing of steps 605→607 is executed until the judgment is negative, and when the judgment is positive in step 607, a process where steps 609→611→613 are executed is repeated. When the judgment is negative in step 613, the processing proceeds to step 615.

In the next step, step 615, the movement time of the paths of the search measurement shot areas and the EGA measurement shot areas is calculated for the shortest path of the search measurement shot areas and the EGA measurement shot areas stored in the main memory, and in step 617, the shortest path, time, and the like of the search measurement shot areas and the EGA measurement shot areas are stored in the storage unit as a file.

FIG. 7A shows an example of an arrangement state of the search measurement shot areas and the EGA measurement shot areas, which are experientially arranged without performing optimization, whereas, FIG. 7B shows an example of an arrangement state of the search measurement shot areas and the EGA measurement shot areas, which have been optimized by the processing of the above subroutine 309 in the embodiment. In both FIGS. 7A and 7B, the number of search measurement shot areas is two and the number of EGA measurement shot areas is eight. S″₁ and S″₂ respectively show the first and the second (measurement order) search measurement shot areas, and G₁ to G₈ respectively show the first to the eighth (calculation order) EGA measurement shot areas. As is shown in FIG. 7A, as the two search measurement shot areas before optimization, the upper left and upper right shot areas of the wafer W are selected, and as the EGA measurement shot areas, two shot areas are arranged evenly, each in the upper right, upper left, lower right, and lower left shot areas on the periphery of the W, however, as is shown in FIG. 7B, the arrangement of the search measurement shot areas and the EGA measurement shot areas is completely changed, and for example, the EGA measurement shots G₁ to G₈ are arranged so that the measurement path becomes counterclockwise to the center of wafer W (the actual movement of wafer stage WST is clockwise).

The number of shots of wafer W shown in FIGS. 7A and 7B is different from the number of shots in FIG. 2A, however, because the present invention can be applied regardless of the total number of shots on the wafer W, this does not create any problems.

Table 1 below shows the evaluation result such as the time required for search measurement and EGA measurement, and the overlay error or the like, in the case the search measurement shot areas and the EGA measurement shot areas shown in FIGS. 7A and 7B are selected.

TABLE 1

| | | After |
|---|---|---|
| | Default | optimization |
| Movement | 2.011 | 1.635 |
| time [sec] | | |
| \hat{σ}_{Sx}[m] | 1.6 × 10⁻⁹ | 1.6 × 10⁻⁹ |
| \hat{σ}_{Sy}[m] | 2.7 × 10⁻⁹ | 2.3 × 10⁻⁹ |
| \hat{σ}_{Rx}[m] | 2.7 × 10⁻⁹ | 2.3 × 10⁻⁹ |
| \hat{σ}_{Sv}[m] | 1.6 × 10⁻⁹ | 1.6 × 10⁻⁹ |
| \hat{σ}_{Ox}[m] | 1.3 × 10⁻¹¹ | 1.3 × 10⁻¹¹ |
| \hat{σ}_{Ov}[m] | 1.3 × 10⁻¹¹ | 1.3 × 10⁻¹¹ |
| \hat{σ}_{dxn}[m] | 5.3 × 10⁻¹¹ | 4.6 × 10⁻¹¹ |
| \hat{σ}_{dyp}[m] | 4.6 × 10⁻¹¹ | 4.6 × 10⁻¹¹ |

As is shown in Table 1, the total movement time between the search measurement shots and the EGA measurement shots before optimization was 2.011[S], but the total movement time after optimization by subroutine 309 was 1.635[S], which is significantly shorter. Furthermore, the table also shows that the error of error parameters and the overlay error in the X-axis direction and the Y-axis direction after optimization are equivalent to or have better accuracy than those before the optimization.

Returning to FIG. 6, after executing step 617, the processing in the subroutine is terminated, and the processing returns to step 311 in FIG. 3.

Next, in steps 311, 313, and 315, search alignment is performed. More specifically, first of all, in step 311, wafer stage WST is driven via stage controller 19 and wafer stage drive section 24 so that the first alignment mark is brought within the detection field of alignment detection system AS, and the image of the first alignment mark is picked up using alignment detection system AS. The magnification of alignment detection system AS at this stage is set to a low magnification. When the imaging signal of the search alignment mark is received from alignment detection system AS, the position information of the first search alignment mark is calculated from the position information and the position information of wafer stage WST sent from wafer interferometer 18 when the image of the first search alignment mark was picked up, and the information is stored in the main memory.

In the next step, step 313, wafer stage WST is driven so as to bring the second search alignment mark within the detection field of alignment detection system AS, and the image of the second search alignment mark is picked up using alignment sensor AS. After this operation, the position information of the second search alignment mark is calculated and stored in the main memory in the same manner as in step 311.

In the next step, step 315, rotation error of the arrangement coordinate system of the shot areas on wafer W to the stage coordinate system is calculated from the position information on the first search alignment mark and the position information on the second search alignment mark. Since the calculation processing of the rotation error is already known, the details will be omitted.

In the next step, step 317, information on a subset of the optimum combination of EGA measurement shot areas is read from a storage unit (not shown), and the number of the EGA measurement shot areas included in the subset and the movement sequence are read. In the case the number of optimized EGA measurement shot areas is 8, each shot area should be made to correspond in the path order as Gₖ (k=1, 2, 3, . . . , 8), as is shown in FIG. 7B. Furthermore, based on the rotation error calculated in step 315, the position coordinate of each EGA measurement shot area is corrected.

In the next step, step 319, the value k of a counter is initialized to 1, and in step 321, wafer stage WST is driven so as to bring the k^{th} alignment mark within the detection field of alignment detection system AS, and alignment marks (MXₖ, MYₖ) of the first EGA measurement shot area are severally imaged using alignment detection system AS. In this case, since k=1, alignment marks (MXₖ, MYₖ) of the first measurement shot are brought within the detection field. When the imaging signal of the search alignment marks are received from alignment detection system AS, the position information of the first alignment mark in the imaging data is detected. Then, based on the position information and the position information on wafer stage WST sent from wafer interferometer 18 at the point when the image of the first alignment mark was picked up, the position information of the first search alignment mark is calculated and the information is stored in the main memory.

In the next step, step 323, the decision is made of whether or not counter value k exceeds the number of the EGA measurement shots (the number of optimized shots). When the judgment is positive, the processing proceeds to step 327, whereas, when the judgment is negative, the processing proceeds to step 325. At this point, because it is still k=1, the judgment is negative, so the processing proceeds to step 325.

In step 325, counter value k is incremented only by 1 (k←k+1), and the processing returns to step 321.

Hereinafter, the process of steps 321→323→325 is repeatedly performed until the judgment turns positive in step 323. Then, the position of alignment marks for the number of shots that are optimized is detected, according to the movement sequence that has also been optimized.

In step 327, based on the detection results of the selected alignment marks, the so-called EGA calculation is performed. In the EGA calculation, the arrangement coordinates of all the shot areas are calculated by the above statistical processing method performed in the EGA method. According to this operation, the arrangement coordinates on the stage coordinate system (stationary coordinate system) of all the shot areas on wafer W are calculated. Details on this processing are disclosed in, for example, Kokai (Japanese Unexamined Patent Application Publication) No. 61-44429, and the corresponding U.S. Pat. No. 4,780,617 or the like, therefore, a detail explanation here will be omitted. As long as the national laws in designated states or elected states, to which this international application is applied, permit, the disclosures cited above in the above publication and the corresponding U.S. patent are fully incorporated herein by reference.

In the next step, step 329, a counter j that shows the arrangement number of the shot area is set to 1, which makes the first shot area an area subject to exposure.

Then, in step 331, wafer stage WST is moved so that the position of wafer W is set to the acceleration starting position for exposing the area subject to exposure on wafer W based on the arrangement coordinate of the area subject to exposure calculated by the EGA operation, and reticle stage RST is moved via stage controller 19 and a reticle stage drive section (not shown) so that the position of reticle R is set to the acceleration starting position.

In step 333, relative scanning between reticle stage RST and wafer stage WST starts. Then, when both stages reach their target scanning speed and move into a constant speed synchronous state, the pattern area of reticle R begins to be illuminated by illumination light IL from illumination system 10, and scanning exposure begins. Then, different areas of the pattern area of reticle R are sequentially illuminated by illumination light IL, and when illumination on the entire pattern area is complete, scanning exposure ends. Accordingly, the pattern of reticle R is reduced and transferred onto the area subject to exposure on wafer W via projection optical system PL.

In step 335, a judgment is made whether or not exposure of all the shot areas have been performed, referring to a counter value j. In this case, since j=1, that is, exposure is performed on only the first shot area, the judgment in step 335 is denied and the processing moves to step 337.

In step 337, the value of counter j is incremented by 1 (+1) to make the next shot area be the area subject to exposure, and then the processing returns to step 331.

Hereinafter, the processing and the judgment in steps 331→333→335→337 are repeated until the judgment in step 335 turns positive.

When pattern transfer onto all the shot areas on wafer W is completed, the judgment in step 335 turns positive, and the processing to moves to step 339.

In step 339, instructions to unload wafer W is given to a wafer loader (not shown). Accordingly, wafer W is transported to a coater developer (not shown) inline connected to exposure apparatus 100 by a wafer transport system (not shown), after being unloaded from wafer holder 25 by the wafer loader (not shown). With this operation, the exposure processing operation is completed.

As it is obvious from the description so far, in the embodiment, the storage unit and the memory of main controller 20 constitute the storage unit. Further, in the embodiment, main controller 20 corresponds to a first area selecting unit, an estimation unit, a set selecting unit, a second area selecting unit, a calculation unit, a decision making unit, a first selecting unit, a second selecting unit, and a transfer unit of the selection unit of the present invention. More specifically, the function of the first area selecting unit is realized by the processing in step 401 (FIG. 4) performed by the CPU of main controller 20, the function of the estimation unit is realized by the processing in steps 403 and 405 (FIG. 4), the function of the set selecting unit is realized by the processing in steps 407 and 409 (FIG. 4), and steps 601 to 617 (FIG. 6), and the function of the second area selecting unit is realized by the processing in steps 501 to 519 (FIG. 5). Further, the function of the selecting unit is realized by the processing in steps 601 to 617 (FIG. 6), and as for the set selecting unit, the calculation unit, and the decision making unit, which are the constituent elements of the selecting unit, the function of the set selecting unit is realized by the processing in step 605, the function of the calculation unit is realized by the processing in step 609, and the decision making unit is realized by the processing in step 611, respectively. Furthermore, the first selecting unit is realized by the processing in steps 401 to 415 (FIG. 4), and the second selecting unit is realized by the processing in steps 601 to 617 (FIG. 6). Still further, the transfer device is realized by the processing in step 333 (FIG. 3). However, it goes without saying that the present invention is not limited to this.

As is described above in detail, according to the selection unit of the embodiment and the selection method executed by the selection unit, in step 401 in FIG. 4, an arbitrary number of shot areas are selected as the EGA measurement shot areas (each element of the subset) from a plurality of shot areas. Then, in step 403, based on the design value (xᵢ, yᵢ) of the position information related to the selected plurality of shot areas and information (σₓᵢ, σ_{yi}) on the accuracy index relative to the position information, the error parameter information on the arrangement of the selected shot areas on wafer W, that is, the maximum likelihood estimate of the error parameter is calculated. Then, in step 405, the overlay error is calculated based on the estimated error parameter, and in step 407, a subset whose overlay error satisfies a first predetermined condition (the overlay error is lower (better) than the threshold value) is selected.

Accordingly, when the shot areas included in the selected subset are used as areas subject to measurement during the wafer alignment by the EGA method, errors of the error parameter for the arrangement of the shot areas on wafer W, overlay errors, and the like can be estimated without actually measuring the position information of the sample measurement shot areas by alignment detection system AS. Accordingly, when the errors of the error parameter or the overlay errors that have been estimated is used, the optimization of the number and the arrangement of the EGA sample measurement shot areas that can satisfy the requirements for alignment accuracy can be performed in a short time.

Further, according to the embodiment, from the shot areas selected by optimizing the number and the arrangement, shot areas having the most preferable movement sequence concerning the total movement time between shot areas are selected in steps 601 to 617 in FIG. 6, therefore when the selected shot areas are used as the shot areas that are actually measured during alignment, the time required for the measurement can be reduced.

More specifically, according to the embodiment, the search measurement shot areas and the EGA measurement shot areas that satisfy a predetermined accuracy criterion are selected, and of a plurality of shot areas selected, a plurality of arbitrary shot areas whose movement sequence is the most preferable concerning the total movement time between shot areas are further selected. Therefore, the optimization of the number and the arrangement of measurement marks and the movement sequence on measurement that can satisfy both the requirements for alignment accuracy and the demand for throughput can be realized.

Further, according to the exposure apparatus and the exposure method executed by the exposure apparatus in this embodiment, because transfer is performed in a state where the position information of the marks formed on wafer W serving as the area subject to measurement is detected with good accuracy after the optimization processing in subroutine 309 is performed, and the position of wafer W is controlled based on the detection results, high exposure accuracy and high throughput can both be realized.

In the embodiment above, the optimization of the sample measurement shot areas was performed after the loading of wafer. However, the present invention is not limited to this. Further, in the case the operating system serving as a basic software that operates on the CPU of the main controller 20 is a multitask OS, the optimization of the sample measurement shot areas may be simultaneously executed during the preparatory operations in steps 301 to 307 in FIG. 3, or the optimization may be performed prior to the preparatory operations. In addition, the above optimization of the sample measurement shot areas does not necessarily have to be performed by main controller 20, and the optimization may be executed by a control computer, which controls a semiconductor production line containing exposure apparatus 100, or by another computer connecting to the control computer or main controller 20 via a communication network (indifferent to cable or wireless).

Moreover, separate computers may execute the optimization processing of the number and the arrangement of the sample measurement shot areas or the like and the optimization processing of the movement sequence. Further, a plurality of computers may share the processing of selecting the shot areas, estimation processing of error parameters and the like, processing of selecting the most preferable subset from the subsets, and the like.

Furthermore, in the embodiment above, a plurality of subsets of shot areas were made, and the shot areas included in a subset selected from the plurality of subsets were used as the sample measurement shot areas. However, the present invention is not limited to this, and an arbitrary combination of the shot areas may be appropriately selected from all the shot areas, and the error parameter of EGA in the combination may be estimated.

Furthermore, in the embodiment above, the combination of shot areas was extracted where optimization was performed on all the aspects; the number, the arrangement of the EGA measurement shot areas, and the movement sequence. However, the present invention is not limited to this, and for example, optimization of the movement sequence does not have to be performed, or on the contrary, only the optimization of the movement sequence may be performed. In the former case, when a plurality of combinations are saved in the file in step 517 in FIG. 5, a subset having a smaller number of the EGA measurement shot areas may be selected as the best subset.

Furthermore, in the embodiment above, when performing optimization of the movement sequence, at least one search method was used, out of the operations research like method, the evolutionary computation, and the combination of the two. The present invention, however, is not limited to this and various types of methods can be applied for the optimization of the movement sequence, which is performed together with the optimization of the number and the arrangement of EGA measurement shot areas. For example, the movement sequence that requires the minimum time can be searched in all the combinations of the EGA measurement shot areas included in the file stored in step 517.

Furthermore, in the embodiment above, the optimization of the movement sequence was performed using at least one search method of the operations research like method, the evolutionary computation, and the combination of the two, and as for the optimization of the number and the arrangement of EGA measurement shot areas performed before the optimization, various methods can be applied. For example, the optimization of the movement sequence may be performed after the optimization of the number and the arrangement of the sample measurement shot areas is performed, using information amount such as Kullback-Leibler information, information criteria represented by Akaike's information criteria (AIC) or the like, order statistics, statistical methods such as EM algorithm, or by using a method where the method described in the above embodiment is combined with the statistical method. More specifically, the present invention can be used appropriately, in combination with the previous method related to EGA.

Further, in the embodiment above, the optimization of the movement sequence was performed after the optimization of the number and the arrangement of EGA measurement shot areas or the like, but the order may be reversed, or the optimization of the number, arrangement and the movement sequence may be performed simultaneously. That is, when calculating the information on overlay error or the like for each subset, the optimization of the movement sequence may be performed, using GA or the like.

Further, in the embodiment above, the optimization was performed on search measurement shot areas where search alignment is performed. However, in the exposure process, there may be a case where search alignment does not have to be performed when the accuracy of prealignment is dramatically high, or in the case the search alignment marks are not provided for each shot area, it goes without saying that the optimization of search measurement shot areas does not have to be performed in such a case. Additionally, the optimization of search measurement shot areas may be performed before the optimization of EGA measurement shot areas.

Further, in the embodiment above, the second search measurement shot area was selected from the shot areas included in a subset of the sample measurement shot areas, however, the second search measurement shot area may be selected from all the shot areas. Furthermore, the first search measurement shot area may be selected from a subset of the sample measurement shot areas.

Further, in the embodiment above, the marks for search alignment and the marks for alignment marks were separate, however, it is also fully possible to use the same marks (more specifically, using the alignment marks as search alignment marks), as is disclosed in, Kokai (Japanese Unexamined Patent Application Publication) No. 11-54407 and its corresponding U.S. Pat. Nos. 6,411,386, 6,587,201, and the like. Accordingly, in such a case, the search alignment marks can be selected from the alignment marks serving as areas subject to measurement. As long as the national laws in designated states or elected states, to which this international application is applied, permit, the disclosures cited above in the above publication and its corresponding U.S. patents are fully incorporated herein by reference.

Furthermore, in this case, the search alignment marks can be selected from the alignment marks of shot areas included in a subset. For example, when the second search alignment mark is also used as the first alignment mark for EGA measurement it is advantageous for throughput. Meanwhile, as is previously described, in the embodiment above, the second search measurement shot area (search alignment mark) was selected from the subset of the EGA measurement shot area (that is, subset of the alignment marks on which EGA measurement is performed) on the assumption that the subset of shot areas is substantially the same as the subset of the alignment marks of the measurement area.

Wafer X mark and wafer Y mark do not necessarily have to be selected from the same shot area. In such a case, since the subset of the shot areas, which is the premise of the embodiment above, is not the same as the subset of the alignment marks of the measurement area, the above optimization processing needs to be performed on the subset of the alignment marks instead of the subset of the shot areas.

Further, in the embodiment above, only one wafer X mark and only one wafer Y mark were arranged in each shot area, however, the number of these marks is not limited and the number of the marks on wafer W may be in any number and any arrangement. For example, the alignment marks do not have to be arranged in each shot area, and a plurality of alignment marks that are formed discretely on the periphery of the wafer may be used. In the case the alignment marks are not arranged in each shot area, the subset of shot areas, which is the premise of the embodiment above, is not the same as the subset of alignment marks of the area subject to measurement, therefore, the above optimization processing has to be performed on the subset of the alignment marks instead of the sub-set of the shot areas. The point is that the subset in the present invention is a subset of marks in every respect, and if a plurality of marks on an object serving as an area subject to measurement are sequentially measured, then, the present invention can be applied and the same effect can be obtained.

Further, when a plurality of alignment marks exist in each shot area as in the embodiment above, optimization can be performed, including the order of the path. In this case, the genetic arrangement corresponding to the movement sequence may include the measurement order of the alignment marks in the shot areas.

As is described above, various modifications can be added to the optimization method of the number and the arrangement of sample measurement shot areas and the optimization method of the movement sequence such as GA in the embodiment above.

Further, the premise of the embodiment above was to use the EGA method; however, any alignment method may be used as long as it is an alignment method for selecting alignment marks subject to measurement. For example, the invention can be applied to an alignment method that can detect diffracted light having a plurality of orders as is disclosed in International Publication WO98/39689.

Furthermore, in the embodiment above, the alignment sensor by the FIA method was used as alignment detection system AS, however, as is previously described, the present invention can be applied to an alignment sensor by the LSA (Laser Step Alignment) method where a laser beam is irradiated on alignment marks arranged in a point sequence shape on wafer W and the mark position is detected by using the beams that have been diffracted or scattered by the marks, or to an alignment sensor that is a combination of such an alignment sensor and the sensor of the above FIA method. In addition, it is naturally possible to apply the present invention to a single alignment sensor that performs detection by irradiating a coherent detection beam on the marks formed on the surface subject to detection, and making two diffracted beams (e.g., of the same order) generated from the marks interfere with each other, or to an alignment sensor which is a sensor of the above FIA method, the LSA method, and the like appropriately combined.

The alignment detection system may be an on-axis method (such as a TTL (Through The Lens) method). Further, the alignment detection system is not limited to a system that performs in a state where the alignment marks are held substantially stationary within the detection field of the alignment detection system, and the system may be based on the method of relatively moving the detection beam irradiated from the alignment detection system and the alignment marks (such as in the above LSA system and homodyne LIA system). In the case of relatively moving the detection beam and the alignment marks, the relative movement direction is desirably in the same direction as the movement direction of wafer stage WST previously described when detecting each alignment mark.

Furthermore, in the embodiment above, the case has been described where the present invention was applied to the scanning exposure apparatus by a step-and-scan method, but it goes without saying that the applicable scope of the present invention is not limited to this. More specifically, the present invention can be suitably applied to an exposure apparatus by a step-and-repeat method and a step-and-stitch method, a mirror projection aligner, a photorepeater, and the like. Moreover, projection optical system PL may by any one of a refraction system, a catadioptric system, or a reflection system, and may be any one of a reduction system, an equal magnification system, or a magnification system.

Moreover, the light source of the exposure apparatus to which the present invention is applied was a KrF excimer laser, an ArF excimer laser, or an F₂ laser, however, other pulsed laser sight sources in the vacuum ultraviolet region may also be used. Additionally, as the illumination light for exposure, a harmonic may be used that is obtained by amplifying a single-wavelength laser beam in the infrared region or visible range emitted by a DFB semiconductor laser or a fiber laser, with a fiber amplifier doped with, for example, erbium (or both erbium and ytterbium), and by converting the wavelength into ultraviolet light using a nonlinear optical crystal.

The exposure apparatus of the above embodiment can be made by incorporating the illumination optical system made up of a plurality of lenses, the projection optical system and alignment detection system AS into the main body of the exposure apparatus and performing optical adjustment, while attaching the reticle stage and the wafer stage consisting of a large number of parts to the main body of the exposure apparatus and connecting wirings and piping, and then performing total adjustment (such as electrical adjustment and operation check). The exposure apparatus is preferably built in a clean room where conditions such as temperature, degree of cleanliness, and the like are controlled.

The present invention can be applied not only to the exposure apparatus for manufacturing semiconductors but also to an exposure apparatus that transfers a device pattern onto a glass plate used for manufacturing displays including liquid crystal display devices or the like, an exposure apparatus that transfers a device patterns onto a ceramic wafer used for manufacturing thin-film magnetic heads, and an exposure apparatus for manufacturing imaging devices (such as a CCD), organic EL, micromachines, DNA chips or the like. In addition, the present invention can also be applied to an exposure apparatus that transfers a circuit pattern onto a glass substrate or a silicon wafer not only when producing microdevices such as semiconductors, but also when producing a reticle or a mask used in exposure apparatus such as an optical exposure apparatus, an EUV exposure apparatus, an X-ray exposure apparatus, or an electron beam exposure apparatus. Normally, in the exposure apparatus that uses DUV (deep (far) ultraviolet) light or VUV (vacuum ultraviolet) light, a transmittance type reticle is used, and as the reticle substrate, materials such as silica glass, fluorine-doped silica glass, fluorite, magnesium fluoride, or crystal are used. Further, in an X-ray exposure apparatus or an electron exposure apparatus by a proximity method, a transmittance type mask (a stencil mask, a membrane mask) is used, and as the mask substrate, silicon wafer or the like is used.

The selection method related to the present invention is applicable not only to an exposure apparatus but also to an apparatus that needs detect several marks after selecting the marks from a plurality of marks formed on an object.

[Device Manufacturing Method]

Next, an embodiment will be described of a device manufacturing method that uses the above exposure apparatus 100 in the lithography step.

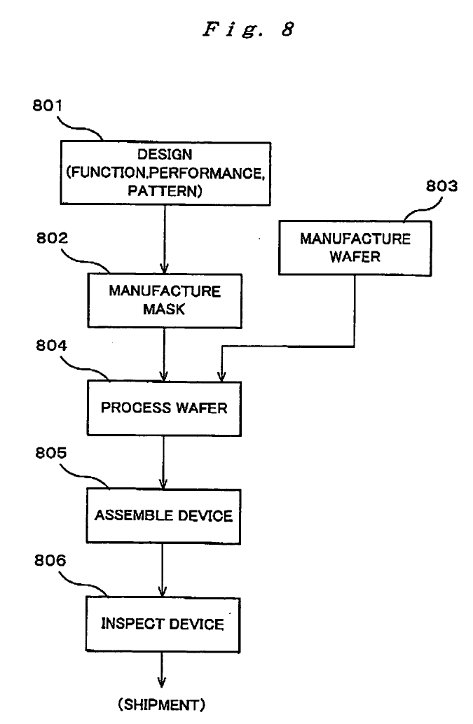

FIG. 8 shows the flowchart of an example when manufacturing a device (a semiconductor chip such as an IC or an LSI, a liquid crystal panel, a CCD, a thin-film magnetic head, a micromachine, and the like) As shown in FIG. 8, in step 801 (design step), function and performance design of device (circuit design of semiconductor device, for example) is performed first, and pattern design to realize the function is performed. Then, in step 802 (mask manufacturing step), a mask on which the designed circuit pattern is formed is manufactured. Meanwhile, in step 803 (wafer manufacturing step), a wafer is manufactured using materials such as silicon.

Next, in step 804 (wafer processing step), the actual circuit and the like are formed on the wafer by lithography or the like in a manner that will be described later, using the mask and the water prepared in steps 801 to 803. Then, in step 805 (device assembly step), device assembly is performed using the wafer processed in step 804. Step 805 includes processes such as the dicing process, the bonding process, and the packaging process (chip encapsulation), and the like when necessary.

Finally, in step 806 (inspection step), tests on operation, durability, and the like are performed on the devices made in step 805. After these steps, the devices are completed and shipped out.

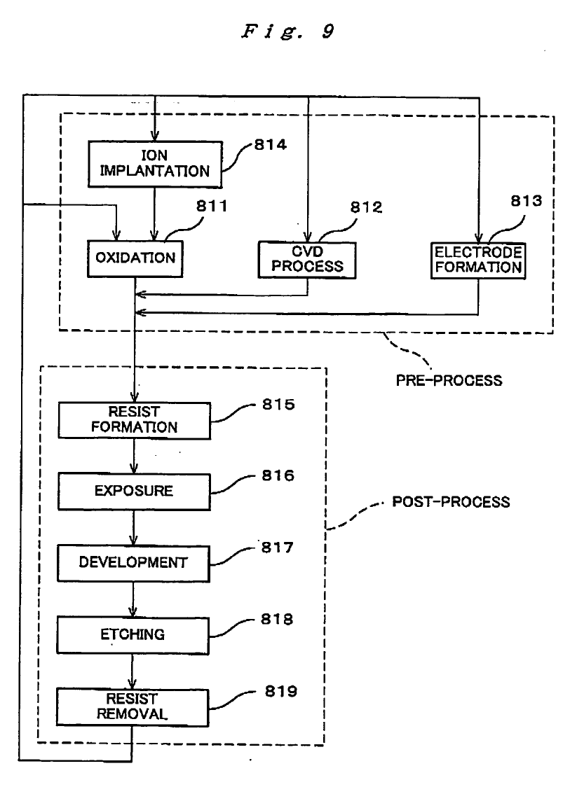

FIG. 9 is a flow chart showing a detailed example of step 804 described above. Referring to FIG. 9, in step 811 (oxidation step), the surface of wafer is oxidized. In step 812 (CDV step), an insulating film is formed on the wafer surface. In step 813 (electrode formation step), an electrode is formed on the wafer by deposition. In step 814 (ion implantation step), ions are implanted into the wafer. Each of the above steps 811 to 814 constitutes the pre-process in each step of wafer processing, and the necessary processing is chosen and is executed at each stage.

When the above-described pre-process ends in each stage of wafer processing, post-process is executed as follows. In the post-process, first in step 815 (resist formation step), a photosensitive agent is coated on the wafer. Then, in step 816 (exposure step), the circuit pattern of the mask is transferred onto the wafer by using exposure apparatus 100 of the embodiment above. Next, in step 817 (development step), the exposed wafer is developed, and in step 818 (etching step), an exposed member of an area other than the area where resist remains is removed by etching. Then, in step 819 (resist removing step), when etching is completed, the resist that is no longer necessary is removed.

By repeatedly performing the pre-process and the post-process, multiple circuit patterns are formed on the wafer.

When the above device manufacturing method of the embodiment is used, because exposure device 100 of the above embodiment is used in the exposure process (step 816), exposure with high accuracy can be realized. As a consequence, devices of higher integration can be produced.

While the above-described embodiment of the present invention is the presently preferred embodiment thereof, those skilled in the art of lithography systems will readily recognize that numerous additions, modifications, and substitutions may be made to the above-described embodiment without departing from the spirit and scope thereof. It is intended that all such modifications, additions, and substitutions fall within the scope of the present invention, which is best defined by the claims appended below.

What is claimed is:

1. A selection method in which a desired area subject to measurement is selected from a plurality of areas subject to measurement formed on an object, said method comprising:
selecting an arbitrary plurality of numbers of areas subject to measurement from said plurality of areas subject to measurement; and
estimating error parameter information on the arrangement of said areas subject to measurement on said object, based on a design value of the position information of each of said plurality of areas subject to measurement selected in said selecting an arbitrary plurality of numbers of areas subject to measurement and information on a predetermined accuracy index related to the position information of said areas subject to measurement.

2. The selection method according to claim 1, said method further comprising:
estimating error information between said design value of said position information of all areas subject to measurement formed on said object and a calculated value of the position information of said areas subject to measurement based on said error parameter information, based on said error parameter information estimated in said second step.

3. The selection method according to claim 1, wherein
in said selecting an arbitrary plurality of numbers of areas subject to measurement, a plurality of subsets of areas subject to measurement are selected, said subsets each including an arbitrary plurality of numbers of areas subject to measurement, and
in said estimating error parameter information on the arrangement of said areas subject to measurement, said error parameter information is estimated for each of said subsets, said method further comprising:
selecting a subset satisfying a first predetermined condition from said plurality of subsets that have been selected, based on said error parameter information estimated in said estimating error parameter information on the arrangement of said areas subject to measurement.

4. The selection method according to claim 3, wherein
said first predetermined condition includes
a condition where one of information on error of said error parameter information and information on overlay error of all areas subject to measurement calculated based on said error parameter information is better than a predetermined accuracy threshold value.

5. The selection method according to claim 3, wherein
when a plurality of subsets selected in said third step exists, said method further comprising:
selecting an optimal subset, using a condition different from said first predetermined condition.

6. The selection method according to claim 5, wherein
in said selecting a subset satisfying a first predetermined condition, when a plurality of subsets are selected that reciprocally have a different numbers of areas subject to measurement,
in said selecting an optimal subset, a subset that has a smaller number of said areas subject to measurement is selected as said optimal subset.

7. The selection method according to claim 5, wherein
in said selecting an optimal subset, a subset that has the most preferable movement sequence related to the total movement time between said plurality of areas subject to measurement included in each of said subsets is selected as said optimal subset.

8. The selection method according to claim 7, wherein
in said selecting an optimal subset, said movement sequence is obtained for each of said subsets using at least one search method of an operations research like method, an evolutionary computation method, and a combination of the two methods, and said optimal subset is selected by comparing said movement sequences that have been obtained.

9. The selection method according to claim 7, said method further comprising:
a measurement sequentially measuring a plurality of areas subject to measurement included in said optimal subset selected in said selecting an optimal subset, using a movement sequence obtained for said optimal subset.

10. The selection method according to claim 3, said method further comprising:
selecting a plurality of areas subject to measurement that is formed on said object and also satisfies a second predetermined condition as an area subject to measurement for measuring a deviation of a coordinate system on said object with respect to a coordinate system that sets a movement position of a moving body where said object is mounted, wherein
in said selecting a plurality of areas subject to measurement that is formed on said object and also satisfies a second predetermined condition, at least one of said plurality of areas subject to measurement that satisfies said second predetermined condition is selected from an area subject to measurement areas included in a subset selected in said third step.

11. The selection method according to claim 10, wherein
said second predetermined condition includes a condition where a reciprocal distance is equal to or longer than a predetermined distance.

12. The selection method according to claim 11, wherein
said second predetermined condition includes a condition of having the most preferable movement sequence related to a total movement time, said total movement time being a total of a reciprocal movement time and movement time among a plurality of areas subject to measurement included in a subset selected in said selecting a subset satisfying a first predetermined condition.

13. The selection method according to claim 12, said method further comprising:
a measurement sequentially measuring a plurality of areas subject to measurement selected in said selecting a plurality of areas subject to measurement and a plurality of areas subject to measurement included in said subset selected in said selecting a subset satisfying a first predetermined condition are sequentially measured, using said movement sequence.

14. The selection method according to claim 1, wherein
said predetermined accuracy index includes an index related to measurement reproducibility of the position information of areas subject to measurement.

15. An exposure method, comprising:
detecting position information of marks serving as areas subject to measurement formed on a substrate, using the selection method according to claim 1; and
transferring a predetermined pattern onto said substrate while position control of said substrate is performed based on said detection result.

16. A device manufacturing method including a lithography process, wherein
in said lithography process, exposure is performed using the exposure method according to claim 15.

17. A selection method in which a desired area subject to measurement is selected from a plurality of areas subject to measurement formed on an object, said method comprising:
selecting an arbitrary plurality of areas subject to measurement having the most preferable movement sequence related to the total movement time between said areas subject to measurement, from said plurality of areas subject to measurement.

18. The selection method according to claim 17, wherein said selecting comprises:
selecting a plurality of subsets of areas subject to measurement, said subsets each including an arbitrary number of areas subject to measurement;
obtaining the most preferable movement sequence related to the total movement time between a plurality of areas subject to measurement included in each of said subsets selected in said selecting a plurality of subsets of areas subject to measurement for each of said subsets; and
comparing solutions of said movement sequence obtained for each of said subsets in said second step, and deciding a subset whose said total movement time is the shortest.

19. The selection method according to claim 17, wherein
said area subject to measurement included in said subsets selected in said selecting a plurality of subsets of areas subject to measurement each has information on overlay error, which is better than a predetermined accuracy threshold value.

20. The selection method according to claim 19, wherein
said information on said overlay error is obtained via statistical processing calculation, said calculation performed on information related to a predetermined accuracy index on the position information of said measurement area and the design value of the position information of each of said arbitrary number of areas subject to measurement.

21. The selection method according to claim 17, wherein
in said selecting, as said arbitrary plurality of areas subject to measurement, at least one of an area subject to measurement for measuring a deviation of a coordinate system on said object with respect to a coordinate system on a moving body where said object is mounted and an area subject to measurement for obtaining error information on the arrangement of said plurality of areas subject to measurement on said object is selected.

22. The selection method according to claim 21, wherein
in said selecting, said arbitrary plurality of areas subject to measurement are selected, using a search method in any one of an operations research like method, an evolutionary computation method, and a combination of the two methods.

23. The selection method according to claim 22, said method further comprising:
a measurement sequentially measuring said arbitrary plurality of areas subject to measurement decided in said selecting step, using said movement sequence that has been obtained using said search method.

24. An exposure method, comprising:
detecting position information of marks serving as areas subject to measurement formed on a substrate, using the selection method according to claim 17; and
transferring a predetermined pattern onto said substrate while position control of said substrate is performed based on said detection result.

25. A device manufacturing method including a lithography process, wherein
in said lithography process, exposure is performed using the exposure method according to claim 24.

26. A selecting method in which a desired area subject to measurement is selected from a plurality of areas subject to measurement formed on an object, said method comprising:
selecting a plurality of areas subject to measurement that are areas subject to measurement so as to obtain error parameter information on the arrangement of said plurality of areas subject to measurement on said object, and also satisfies a predetermined accuracy criterion; and
selecting, of said plurality of areas subject to measurement selected in said selecting a plurality of areas subject to measurement, an arbitrary plurality of areas subject to measurement that have the most preferable movement sequence related to the total movement time between said areas subject to measurement.

27. The selection method according to claim 26 wherein
said error parameter information is obtained by processing the design value of the position information of each of said plurality of areas subject to measurement selected in said selecting a plurality of areas subject to measurement and information on a predetermined accuracy index related to the position information of said areas subject to measurement by statistical calculation.

28. The selection method according to claim 26 wherein
said predetermined accuracy criterion includes a predetermined threshold value for one of information on the error of said error parameter information and information on overlay error of all said areas subject to measurement that are calculated based on said error parameter.

29. An exposure method, comprising:
detecting position information of marks serving as areas subject to measurement formed on a substrate, using the selection method according to claim 26; and
transferring a predetermined pattern onto said substrate while position control of said substrate is performed based on said detection result.

30. A device manufacturing method including a lithography process, wherein
in said lithography process, exposure is performed using the exposure method according to claim 29.

31. A selection unit that selects a desired area subject to measurement from a plurality of areas subject to measurement formed on an object, said unit comprising:
a first area selecting unit that selects an arbitrary plurality of numbers of areas subject to measurement from said plurality of areas subject to measurement; and
an estimation unit that estimates error parameter information on the arrangement of said areas subject to measurement on said object, based on a design value of the position information of each of said plurality of areas subject to measurement selected by said first area selecting unit and information on a predetermined accuracy index related to the position information of said areas subject to measurement.

32. The selection unit according to claim 31 wherein
said first area selecting unit selects a plurality of subsets of areas subject to measurement, said subsets each including an arbitrary plurality of numbers of areas subject to measurement, and
said estimation unit estimates said error parameter information for each of said subsets, said selection unit further comprising:
a set selecting unit that selects a subset satisfying a first predetermined condition from said plurality of subsets that have been selected, based on said error parameter information estimated by said estimation unit.

33. The selection unit according to claim 32 wherein
said first predetermined condition includes
a condition where one of information on error of said error parameter information and information on overlay error of all areas subject to measurement calculated based on said error parameter information is better than a predetermined accuracy threshold value.

34. The selection unit according to claim 32, wherein
said set selecting unit selects an optimal subset using a condition different from said first predetermined condition when a plurality of selected subsets exists.

35. The selection unit according to claim 34, wherein
said set selecting unit selects a subset that has the most preferable movement sequence related to the total movement time between said plurality of areas subject to measurement included in each of said subsets as said optimal subset.

36. The selection unit according to claim 35, said unit further comprising:
a measurement unit that sequentially measures a plurality of areas subject to measurement included in said optimal subset selected by said set selecting unit are sequentially measured, using a movement sequence obtained for said optimal subset.

37. The selection unit according to claim 32, said unit further comprising:
a second area selecting unit that selects a plurality of areas subject to measurement that is formed on said object and also satisfies a second predetermined condition are selected as an area subject to measurement for measuring a deviation of a coordinate system on said object with respect to a coordinate system that sets a movement position of a moving body where said object is mounted, wherein
said second area selecting unit selects at least one of said plurality of areas subject to measurement that satisfies said second predetermined condition from an area subject to measurement areas included in a subset selected by said set selecting unit.

38. The selection unit according to claim 37, wherein
said second predetermined condition includes a condition where a reciprocal distance is equal to or longer than a predetermined distance.

39. The selection unit according to claim 38, wherein
said second predetermined condition includes a condition of having the most preferable movement sequence related to a total movement time, said total movement time being a total of a reciprocal movement time and movement time among a plurality of areas subject to measurement included in a subset selected by said set selecting unit.

40. The selection unit according to claim 31, wherein
said predetermined accuracy index includes an index related to measurement reproducibility of the position information of areas subject to measurement.

41. An exposure apparatus, comprising:
a selection unit according to claim 31;
a detection unit that detects the position information of marks serving as areas subject to measurement formed on a substrate based on measurement results of said selection unit; and
a transfer unit that transfers a predetermined pattern onto said substrate while positional control of said substrate is performed based on detection results of said detection unit.

42. A device manufacturing method including a lithography process, wherein
in said lithography process, exposure is performed using the exposure apparatus according to claim 41.

43. A selection unit that selects a desired area subject to measurement from a plurality of areas subject to measurement formed on an object, said unit comprising:
a selecting unit that selects an arbitrary plurality of areas subject to measurement having the most preferable movement sequence related to the total movement time between said areas subject to measurement from said plurality of areas subject to measurement; and
a measurement instrument that measures said selected plurality of areas subject to measurement.

44. The selection unit according to claim 43, wherein said selecting unit comprises:
a set selecting unit that selects a plurality of subsets of areas subject to measurement, said subsets each including an arbitrary number of areas subject to measurement;
a calculation unit that obtains the most preferable movement sequence related to the total movement time between a plurality of areas subject to measurement included in each of said subsets selected by said set selecting unit is obtained for each of said subsets; and
a decision making unit that compares solutions of said movement sequence obtained for each of said subsets by said calculation unit, and decides a subset whose said total movement time is the shortest.

45. The selection unit according to claim 43, wherein
said area subject to measurement included in said subsets selected by set selecting unit each has information on overlay error, which is better than a predetermined accuracy threshold value.

46. The selection unit according to claim 43, wherein
said selecting unit selects at least one of an area subject to measurement for measuring a deviation of a coordinate system on said object with respect to a coordinate system on a moving body where said object is mounted and an area subject to measurement for obtaining error information on the arrangement of said plurality of areas subject to measurement on said object as said arbitrary plurality of areas subject to measurement.

47. The selection unit according to claim 46, wherein
said selecting unit selects said arbitrary plurality of areas subject to measurement, using a search method in any one of an operations research like method, an evolutionary computation method, and a combination of the two methods.

48. The selection unit according to claim 47, wherein
said measurement instrument sequentially measures said arbitrary plurality of areas subject to measurement decided by said selecting unit, using said movement sequence that has been obtained using said search method.

49. An exposure apparatus, comprising:
a selection unit according to claim 43;
a detection unit that detects the position information of marks serving as areas subject to measurement formed on a substrate based on measurement results of said selection unit; and
a transfer unit that transfers a predetermined pattern onto said substrate while positional control of said substrate is performed based on detection results of said detection unit.

50. A device manufacturing method including a lithography process, wherein
in said lithography process, exposure is performed using the exposure apparatus according to claim 49.

51. A selection unit that selects a desired measurement area from a plurality of measurement areas formed on an object, said unit comprising:
a first selecting unit that selects a plurality of areas subject to measurement that are areas subject to measurement so as to obtain error parameter information on the arrangement of said plurality of areas subject to measurement on said object, and also satisfies a predetermined accuracy criterion; and
a second selecting unit that selects an arbitrary plurality of areas subject to measurement that have the most preferable movement sequence related to the total movement time between said areas subject to measurement from said plurality of areas subject to measurement selected by said first selecting unit.

52. An exposure apparatus, comprising:
a selection unit according to claim 51;
a detection unit that detects the position information of marks serving as areas subject to measurement formed on a substrate based on measurement results of said selection unit; and
a transfer unit that transfers a predetermined pattern onto said substrate while positional control of said substrate is performed based on detection results of said detection unit.

53. A device manufacturing method including a lithography process, wherein
in said lithography process, exposure is performed using the exposure apparatus according to claim 52.
